(19) United States
(12) Patent Application Publication
(10) Pub. No.: US 2020/0333925 A1
(43) Pub. Date: Oct. 22, 2020

(54) SYSTEM AND METHOD FOR NAVIGATING INTERFACES USING TOUCH GESTURE INPUTS

(71) Applicant: MICROSOFT TECHNOLOGY LICENSING, LLC, Redmond, WA (US)

(72) Inventor: Christopher Andrews JUNG, Seattle, WA (US)

(73) Assignee: MICROSOFT TECHNOLOGY LICENSING, LLC, Redmond, WA (US)

(21) Appl. No.: 16/389,407

(22) Filed: Apr. 19, 2019

(51) Int. Cl. G06F 3/0482; G06F 3/0488; G06F 3/0484

(52) U.S. Cl. CPC G06F 3/0482; G06F 3/0484; G06F 3/04883

(57) ABSTRACT

A touch gesture navigation system and process for facilitating interaction with options on smaller touchscreens. As an example, a user may access a menu of options associated with a portion of electronic document via a user interface. In order to navigate between the presented options, the user may swipe in a first direction. Each time the user swipes the target selection can move to an adjacent option in the menu. The user can then swipe in a different direction to confirm the selection and actuate a task associated with that selection. In some implementations, the presentation of such a menu can automatically enable these types of touch gesture navigational mechanism, and the dismissal of such a menu can also automatically disable the touch gesture navigational mechanism.

### BACKGROUND

Electronic devices, including portable electronic devices, have gained widespread use and are now configured to provide a variety of functions including, for example, communications as well as document viewing and generation application functions. For example, users may dictate speech to a mobile device for capturing words as text on the device. In some other cases, users may open and edit documents on their mobile devices. Such devices often provide users with touch-sensitive screens for use as an input mechanism; in many instances, the touchscreen is the primary input mechanism. In addition, with many laptops, a touch-based track pad may be used as a mechanism for controlling a cursor or pointing device. Designing software applications for devices that utilize these touch-based input devices can be challenging, particularly when there are few alternate input mechanisms (such as a conventional mouse or physical keyboard) and the size of the display is small.

Devices with smaller form factors, such as mobile touch-sensitive devices including tablets and smartphones with touch screens, can be configured to detect touch-based gestures (e.g., ‘tap’, ‘pan’, ‘swipe’, ‘pinch’, ‘de-pinch’, and ‘rotate’ gestures). These types of devices often use the detected gestures to manipulate user interfaces and to navigate between user interfaces in software applications on the device. However, users often experience difficulty when attempting to interact with electronic content that is optimized for large-screen viewing on a mobile device. Users may attempt to make touch gesture based edits on small-screen interfaces that trigger an undesired response, requiring the user to undo any actions performed in response to the misinterpreted gesture. The user must then try to repeat the touch gesture, which can be inefficient and frustrating. Thus, there remain significant areas for new and improved ideas for the more effective and intuitive management of touch gesture inputs for device navigation in software applications.

### SUMMARY

A system, in accordance with a first aspect of this disclosure, includes a processor and one or more computer readable media. The computer readable media include instructions which, when executed by the processor, cause the processor to display, on a first device, a first user interface for interacting with a first application, the first user interface including a plurality of actuatable options for selecting content available via the first application, the plurality of actuatable options including a first option, as well as receive, via the touch-screen display, a first user input corresponding to a selection of the first option. In addition, the instructions cause the processor to automatically display, in response to the first user selection, a first menu comprising a first set of sub-options that includes a first sub-option, a second sub-option, and a third sub-option, and wherein the first sub-option is associated with a visual indicator that denotes a currently targeted selection, and also receive, via the touch-screen display, a second user input corresponding to a navigation between the first sub-option and the second sub-option, the second user input comprising a first swiping touch gesture in a first direction aligned with a first axis, wherein the visual indicator moves from the first sub-option to the second sub-option in response to the second user input. Furthermore, the instructions cause the processor to receive, via the touch-screen display, a third user input corresponding to a selection of the second sub-option, the third user input comprising a second swiping touch gesture in a second direction aligned with a second axis that is substantially perpendicular relative to the first axis, and automatically trigger execution of a task associated with the selection of the second sub-option.

A method of navigating user interface options via a touch-screen display of a computing device, in accordance with a second aspect of this disclosure, includes a step of displaying, on a first device, a first user interface for interacting with a first application, the first user interface including a plurality of actuatable options for selecting content available via the first application, the plurality of actuatable options including a first option, followed by a step of receiving, via the touch-screen display, a first user input corresponding to a selection of the first option. In addition, the method includes automatically displaying, in response to the first user selection, a first menu comprising a first set of sub-options that includes a first sub-option, a second sub-option, and a third sub-option, and wherein the first sub-option is associated with a visual indicator that denotes a currently targeted selection. In addition, the method includes receiving, via the touch-screen display, a second user input corresponding to a navigation between the first sub-option and the second sub-option, the second user input comprising a first swiping touch gesture in a first direction aligned with a first axis, wherein the visual indicator moves from the first sub-option to the second sub-option in response to the second user input. The method further includes receiving, via the touch-screen display, a third user input corresponding to a selection of the second sub-option, the third user input comprising a second swiping touch gesture in a second direction aligned with a second axis that is substantially perpendicular relative to the first axis, and then automatically triggering execution of a task associated with the selection of the second sub-option.

A computer readable medium, in accord with a third aspect of this disclosure, includes instructions stored therein which, when executed by a processor, cause the processor to perform operations including display, on a first device, a first user interface for interacting with a first application, the first user interface including a plurality of actuatable options for selecting content available via the first application, the plurality of actuatable options including a first option. In addition, the instructions cause the processor to perform operations including receive, via the touch-screen display, a first user input corresponding to a selection of the first option, and automatically display, in response to the first user selection, a first menu comprising a first set of sub-options that includes a first sub-option, a second sub-option, and a third sub-option, and wherein the first sub-option is associated with a visual indicator that denotes a currently targeted selection. The instructions further cause the processor to perform operations including receive, via the touch-screen display, a second user input corresponding to a navigation between the first sub-option and the second sub-option, the second user input comprising a first swiping touch gesture in a first direction aligned with a first axis, wherein the visual indicator moves from the first sub-option to the second sub-option in response to the second user input. In addition, the instructions cause the processor to perform operations including receive, via the touch-screen display, a third user input corresponding to a selection of the second sub-option, the third user input comprising a second swiping touch gesture in a second direction aligned with a second axis that is substantially perpendicular relative to the first axis, and automatically trigger execution of a task associated with the selection of the second sub-option.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is an example of a computing environment with an implementation of a touch-based navigation process;

FIG. 2 is a computing display for a mobile device illustrating an implementation of a client application for interfacing with text-based content;

FIG. 3 is a computing display for a mobile device illustrating an implementation of a user input requesting additional options for a particular portion of the text-based content;

FIG. 4 is a computing display for a mobile device illustrating an implementation of a menu by which users may select from alternate options;

FIG. 5 illustrates an implementation of a navigation tool interface where a user is engaging with a suggestions menu associated a particular term;

FIG. 6 is a computing display for a mobile device illustrating an implementation of a change in location of the current target in response to a touch gesture input;

FIG. 7 illustrates an implementation of a navigation tool interface where a user is selecting an option from the suggestions menu;

FIG. 8 is a computing display for a mobile device illustrating an implementation where a portion of the text-based content has been modified;

FIGS. 9A-9D illustrate an implementation of a user dismissing a navigation tool interface;

FIG. 10 is a computing display illustrating an implementation of a spreadsheet-type client application where a user is moving through options offered via a menu associated a particular cell via a navigation tool interface;

FIG. 11 is a computing display illustrating an implementation of a spreadsheet client application where a user is selecting an option associated a particular cell via a navigation tool interface;

FIG. 12 is a computing display illustrating an implementation of a spreadsheet client application where a cell has been modified;

FIGS. 13A-13F illustrate an implementation of a user interacting with a cascading menu using navigational gesture inputs;

FIG. 14 is a flow diagram of an implementation of a method of navigating on a computing device using touch gesture inputs;

FIG. 15 is a block diagram of an example computing device, which may be used to provide implementations of the mechanisms described herein; and

FIG. 16 is a block diagram illustrating components of an example machine configured to read instructions from a machine-readable medium.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

For many users, mobile devices afford convenience due to their portability and small size. However, when compared with desktop and even laptop screens, phone screens accommodate significantly less content. Thus, screen size can be a serious limitation for mobile device applications. For example, content displayed on a 30-inch monitor would require five screens on the smaller 4-inch screen typical of a mobile phone. As a result, mobile device users have had to incur a higher interaction cost in order to access and navigate through the same amount of information. This makes the incorporation of new design elements or content on the mobile screen very challenging. In other words, without improved user interaction input methods, developers and users are required to constantly adapt to content and features that are often too small for human fingers to select with reliable accuracy. For example, on touch devices, users must use their fingers to click links and buttons on the screen, which significantly decrease the accuracy of clicks. This is also known as the ‘fat finger problem’. This has meant developers must consider the size and proximity of all clickable elements, ensuring they are of sufficient size to reliably touch with a human finger and far enough apart that users do not accidentally touch the wrong element. Navigation and control bars are of particular importance as they include numerous clickable elements (making accidental clicks more likely) that all have significant consequences to the page (making accidental clicks more critical).

The following implementations introduce touch gesture input mechanisms that can facilitate a user's interaction experience and provide more reliable and efficient tools for accurate selections of elements offered by an interface. Users can enjoy a more intuitive orientation as they receive, absorb, and interact with information contained in (for example) a document or other displayed elements. For example, using the proposed systems, a user may comfortably access and view text while moving quickly through options and menus that do not rely on input associated with the above-mentioned ‘fat finger problem’. Such touch gestures will instead offer users the ability to move between one option and another, as well as select an option, by broad or sweeping swipe-gestures on the screen, where the system is configured to navigate across a menu by single, discrete steps (or scroll units) regardless of the distance a finger travels during the swipe.

As introduced above, applications such as word processors, publishers, spreadsheets, presentation software, and others can be used to generate electronic documents or content. Generally, the term “electronic document” or “document” includes any digital data that may be presented (e.g., visually or audibly presented), including but not limited to an electronic content item and portions thereof, a media item, a media stream, a web page, a hypertext document, an image, digital video or a video recording, digital audio or an audio recording, animation, a markup language document, such as a HyperText Markup Language (HTML) or eXtensible Markup Language (XML) document, a form having blank components to accept entered data, or data describing the application of a GUI, image documents that include images of text that may be extracted using optical character recognition (OCR) processes, documents that may include mixtures of text and images, such as Portable Document Format (PDF) documents or PowerPoint (PPT) documents, etc., or any type or format of document from which text may be extracted or that may be converted to text, and other digital data. As an example, this electronic content may include word processing documents, spreadsheets, presentations, e-books, or other digital-based media.

Furthermore, within some types of documents, the electronic content can be understood to include a plurality of content elements or content portions. In general, a content portion includes any part of electronic content that is defined or discernable as a part. For example, a content portion may be automatically discerned from a characteristic of the content portion itself (e.g., a letter, number, word, sentence, paragraph, section, image, symbol, or chapter of an electronic document, or other file format designation) or may be manually defined by a reviewer or end-user (e.g., selected collection of words in an electronic document, a selected portion of a digital image, a selected group of cells in a spreadsheet, a selected region in a slide from a presentation). Examples of content portions include portions or pieces of electronic text or other material within an electronic document, comments, dynamic content in the form of portions of media streams, such as sections of digital video or frames or sets of frames of digital video or digital audio, dynamic content in the form of segments or frames of animations, electronic forms, form templates, form elements, form data, actuatable element specifications or executable instructions, and various elements presentable or accessible by reviewers within electronic content, including instances of scripted and non-scripted dynamic content and the like.

In addition, a user generally refers to one who views, develops, collaborates, suggests, listens, receives, shares, reviews, revises, or disseminates pieces of electronic content, including the creation, viewing, or updating of comments associated with the electronic content. A user includes a reader or listener of electronic content based application programs, as well as a user of the apparatus and systems described herein. Furthermore, the term “software application”, “software”, or “application” refers to a computer program that performs useful work, generally unrelated to the computer itself. Some non-limiting examples of software applications include text-to-speech applications, dictation or speech-to-text applications, word processors, spreadsheets, slideshows, presentation design applications, accounting systems, and telecommunication programs, as well as gaming software, utility and productivity tools, mobile applications, presentation graphics, and other productivity software. These are non-limiting examples, and any other electronic content creation, editing, viewing, or collaboration application may benefit from the disclosed implementations.

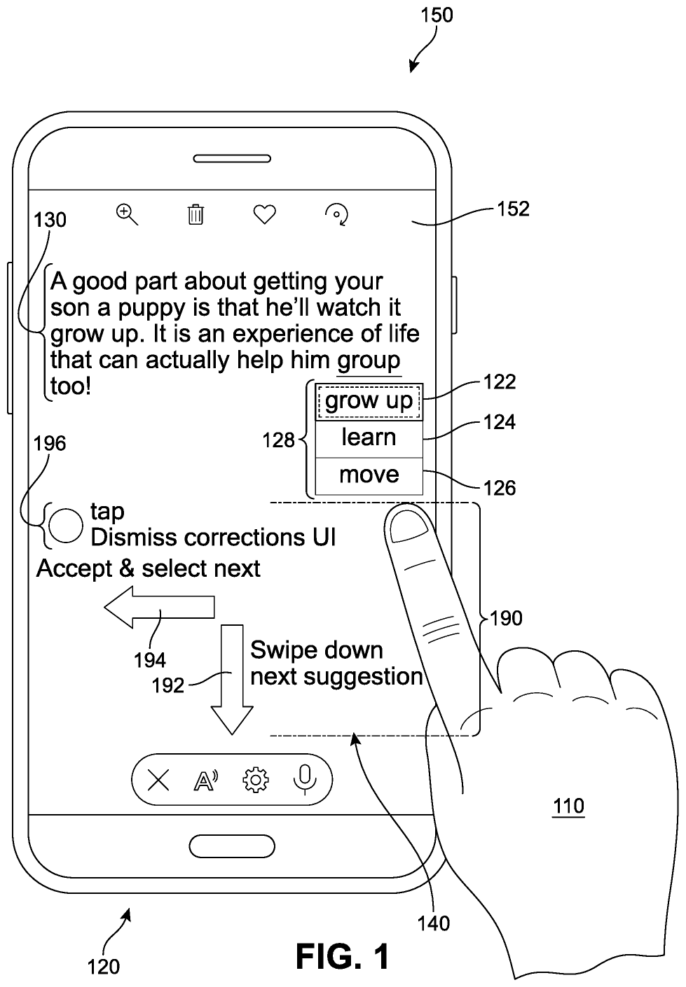

In order to better introduce the systems and methods to the reader, FIG. 1 presents a high-level example of a representative computing experience (“experience”) 150 for implementing a touch-based navigation management system. In different implementations, the experience 150 can include one or more computing device end-users, or simply “users”. One or more users can interact with or manipulate data presented via a user device. The various features and activities illustrated in FIG. 1 are described generally, with further details and examples presented in connection with later figures.

As an example, a first user 110 (represented by a hand) is shown in FIG. 1. In this case, the first user 110 is a user of a first mobile device (“first device”) 120, and is accessing a dictation or text editing client application (“text editing client”), as represented by a first user interface (“first interface”) 152 presented on a device display 140. In general, an “interface” can be understood to refer to a mechanism for communicating content through a client application to an application user. For example, interfaces may include pop-up windows that may be presented to a user via native application user interfaces (UIs), controls, actuatable interfaces, interactive buttons, or other objects that may be shown to a user through native application UIs, as well as mechanisms that are native to a particular application for presenting associated content with those native controls. Furthermore, an “actuation” or “actuation event” refers to an event (or specific sequence of events) associated with a particular input or use of an application via an interface, which can trigger a change in the display of the application. Similarly, a ‘targeted’ option or target option refers to the option that is current navigation destination, without the target having been actuated. In other words, when a user moves their selection tool or navigational indicator from a first option or location of the interface to another, second option or location, it can be understood that the current target has switched from the first option to the second option.

In addition, a “native control” refers to a mechanism for communicating content through a client application to an application user. For example, native controls may include actuatable or selectable options or “buttons” that may be presented to a user via native application UIs, touch-screen access points, menus items, or other virtual objects that may be shown to a user through native application UIs or segments of a larger interface, as well as mechanisms that are native to a particular application for presenting associated content with those native controls. The term “asset” refers to content that may be presented in association with a native control in a native application. Thus, as non-limiting examples, an asset may include text in an actuatable pop-up window, audio associated with the interactive click or selection of a button or other native application object, video associated with a user interface, or other such information presentation.

The first device 120 (and others shown herein) is a mobile phone, and the device display 140 provides a touch-screen facility. However, in other implementations, the device may be any computing device such as a desktop or laptop computer, a tablet, or any other computer system having a touch-input mechanism. The first device 120 executes an operating system such as Microsoft Windows®, Mac OS®, Unix®, or other operating system, and includes memory, storage, a network interface, and other computer hardware not illustrated herein. The first device 120 can be configured to respond to instructions generated by the text editing client 100. In addition, in some implementations, the first device 120 can be connected to a server, and/or an online or cloud-based computing storage service (“cloud storage service”). As first user 110 accesses or interacts with electronic content via first device 120, various tools, options, or menus for use with the first interface 152 may be provided.

As first user 110 accesses first device 120, they may occasionally interact more directly with text-based content 130 as it is displayed. As will be described in greater detail below, the proposed systems can be configured to provide users the ability to more precisely select a target or otherwise navigate among different regions of an interface. In FIG. 1, the first user 110 is viewing a first menu 128 in which a plurality of suggested or alternate terms are offered, in this case for replacing terms or phrases already generated and presented. Specifically, a term “group” is identified as being potentially undesirable, and the first menu 128 comprises a list of options that suggest replacements for the designated term.

As noted earlier, in cases where the user is expected to pinpoint their touch-based input in order to select an option is unwieldy and often error-prone. In different implementations, the first user 110 may instead be offered a different or alternative mechanism by which to navigate the first menu 128. One implementation is shown in FIG. 1 where, below the text-based content 130, a navigation sub-interface 190 is presented in conjunction with the first interface 152. In one implementation, the navigation sub-interface 190 may be hidden, minimized, or otherwise unavailable until the user submits some type of triggering input that initiates presentation of or makes available the mechanisms associated with navigation sub-interface 190. In some implementations, the navigation sub-interface 190 can also offer guidance or a visual tutorial to the user for making use of the navigation sub-interface 190 tools and/or to move through and/or select options on the menu. In this case, the navigation sub-interface 190 includes a first guide 192, a second guide 194, and a third guide 196. The guides shown herein are for purposes of illustration only, and in other implementations may differ in appearance or may not be shown.

The first guide 192 (“Swipe down/next suggestion”), presented alongside a graphical representation of the gesture, advises the first user 110 that the system is configured to receive and interpret a first type of input as corresponding to a navigation between the first option 122 and the second option 124. In this example, the first type of input is a touch gesture that includes a swiping touch gesture in a downward direction. Thus, in response to this type of touch gesture input, the option that is currently shown as targeted will be ‘released’ and the next available option will become the current target option. It should be understood that in different implementations, the distance of the swipe as submitted by the user need not have an effect on the outcome of the response by the system. In other words, in one implementation, a long swipe extending a first distance ‘down’ the display or a short swipe extending a second distance smaller than the first distance ‘down’ the display can each result in the same output of a single step or movement from a first option to a second option.

Similarly, the second guide 194 (“Accept & select next”), presented alongside a graphical representation of the gesture, advises the first user 110 that the system is configured to receive and interpret a second type of input as corresponding to an actuation of the currently targeted option in the menu. In this example, the second type of input is a touch gesture that includes a swiping touch gesture in a leftward direction. In other words, in response to this type of touch gesture input, the option that is currently shown as targeted will be accepted or actuated. In addition, in this implementation, if any additional terms are underlined as potential changes to the text-based content 130, the next term being paired with such a suggestions menu will pop-up or otherwise become available for facilitating the user's next word replacement task.

Furthermore, the third guide 196 (“tap/Dismiss corrections UI”), presented alongside a graphical representation of the input type, advises the first user 110 that the system is configured to receive and interpret a third type of input as corresponding to a request to close or dismiss the navigation sub-menu 190. In this example, the third type of input is a touch tap that includes a user tap-contact on the device display 140. In other words, in response to this type of touch input, the navigation sub-interface 190 and its input mechanisms will be dismissed. This can be followed by a reversion to the primary interface (e.g., first interface 152). By enabling this type of navigation between options that are being presented in a relatively compact display, the user can be confident that even in scenarios where there may be instability in the user's location (e.g., use of the device while in transit via a car, bus, train, plane, boat, etc.), an exact “bullseye” need not be required to ensure the selection of the desired option. This mechanism in turn can improve the ability of individuals to manage their consumption of electronic documents and facilitate a more natural and effective engagement with the information contained in such documents. As will be discussed below, these systems and methods can also offer an effective set of interaction tools for users to modify or generate electronic content, regardless of screen size, thereby enriching overall user experience.

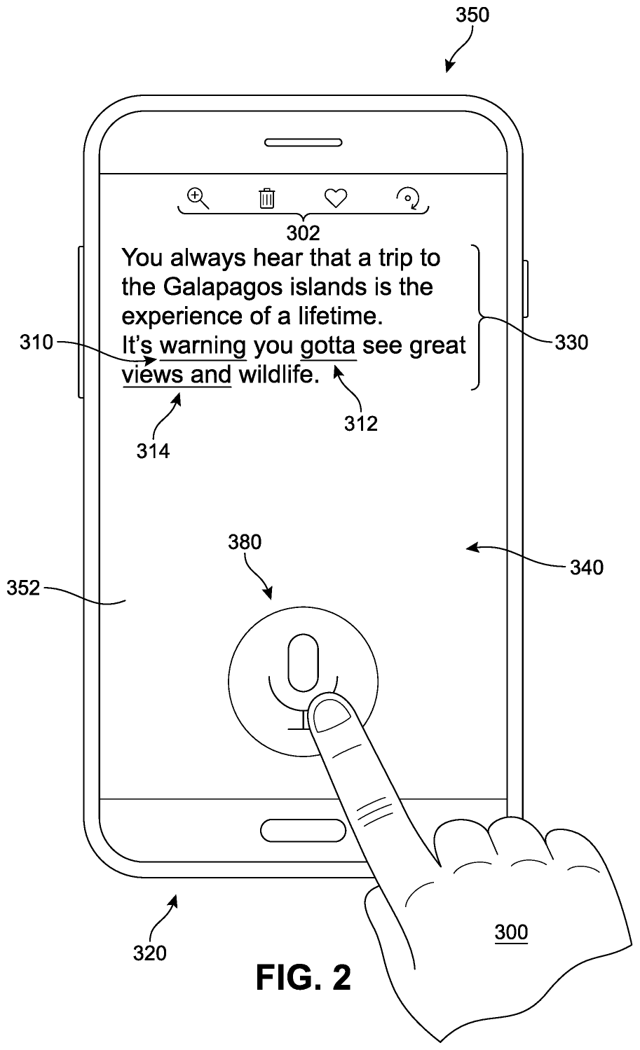

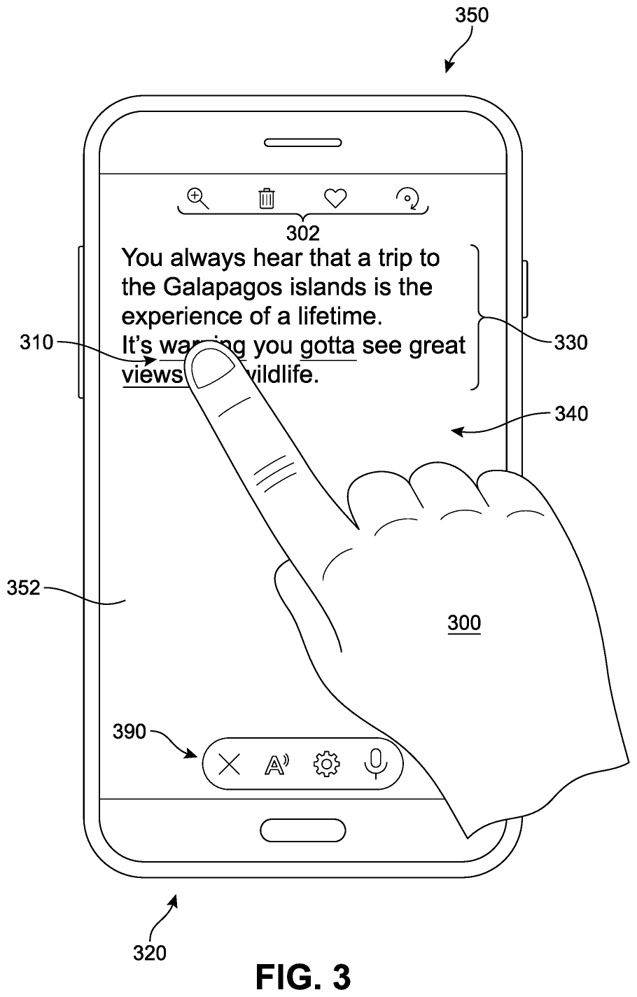

For purpose of clarity for the reader, FIGS. 2-8 present a scenario 350 illustrating one possible example of the processes disclosed herein. In FIGS. 2 and 3, an introduction to an implementation of a touch-based navigational system is shown. In FIG. 2, a second user 300 (represented by a hand) is also accessing a dictation-type client application (“client application”) 352, as represented by a second user interface (“second interface”) shown on a device display 340 of a second device 320. While the client application 352 comprises a simplified word processor program displaying a text-based content in FIG. 2, in other implementations, the client application 352 can represent a version of Microsoft Word®, or another word processing program, such as Apple Pages®, Corel WordPerfect®, Google Docs®, IBM Lotus Word Pro® and other word editing programs. In addition, in still other implementations, the client application may include any other software applications within the Microsoft Office Suite® or array of Microsoft® products as well as any non-Microsoft® based applications for modifying and/or working with electronic content. In this example, a first electronic content (“first content”) 330 has been generated or otherwise obtained and is being shown to the user.

In some implementations, the client application 352 can include provisions for facilitating user identification of potential errors in an electronic content. In FIG. 2, the first content 330 is further overlaid by a plurality of visual indicators that indicate which terms in the content may be misspelled or otherwise incorrect. For purposes of this example, these terms are highlighted or otherwise distinguished by an underlining effect. In FIG. 2, a first term 310 (“warning”), a second term (“gotta”) 312, and a third term 314 (“views and”) are identified for the user's review. In some implementations, these opportunities may be displayed or otherwise provided to the user in response to a detection of a portion of content being identified as potentially modifiable, for example in the context of the overall content. In some implementations, the term may be associated with an option that can be triggered by actuation of the visual indicator itself (i.e., the visual indicator may correspond to the option or initiate access to additional options).

In this specific example, the second user 300 is pressing or otherwise actuating a first application button 380 provided by the client application 352. In response to the actuation event, the client application 352 can pause the dictation function. The first content 330, comprising a portion of text—in this case, text transcribed in response to a dictation—is also presented adjacent to an optional first application toolbar 302. The first application toolbar 302 includes options for facilitating user modification and interaction with the first electronic content (“first content”) 330. It should be understood that while a wide range of client productivity applications and software can benefit from the proposed implementations, the specifics of each client application (e.g., client application menus and options or other display aspects or visual properties) are for purposes of example only. In other words, menus or other features associated with the dictation software can vary widely and still incorporate the proposed systems, as will be illustrated below. In this case, the first application toolbar 302 offers options such as display size adjustment tool (‘magnifying glass’), a delete or ‘trash’ tool, a favorites marker, and an Undo tool).

In FIG. 3, the first application button 380 has been dismissed, and instead a second application toolbar 390 appears in a lower portion of the device display 340. In different implementations, the second application toolbar 390 can include a plurality of options, such as an exit option, a text formatting option, a settings option, and a (return to) dictation option. In FIG. 3, the second user 300 has opted to tap or otherwise select the first term 310 for review. Thus, in some implementations, the visual indicator can also serve as a representation of the availability of an actuatable option associated with the highlighted term that may facilitate modifications or edits.

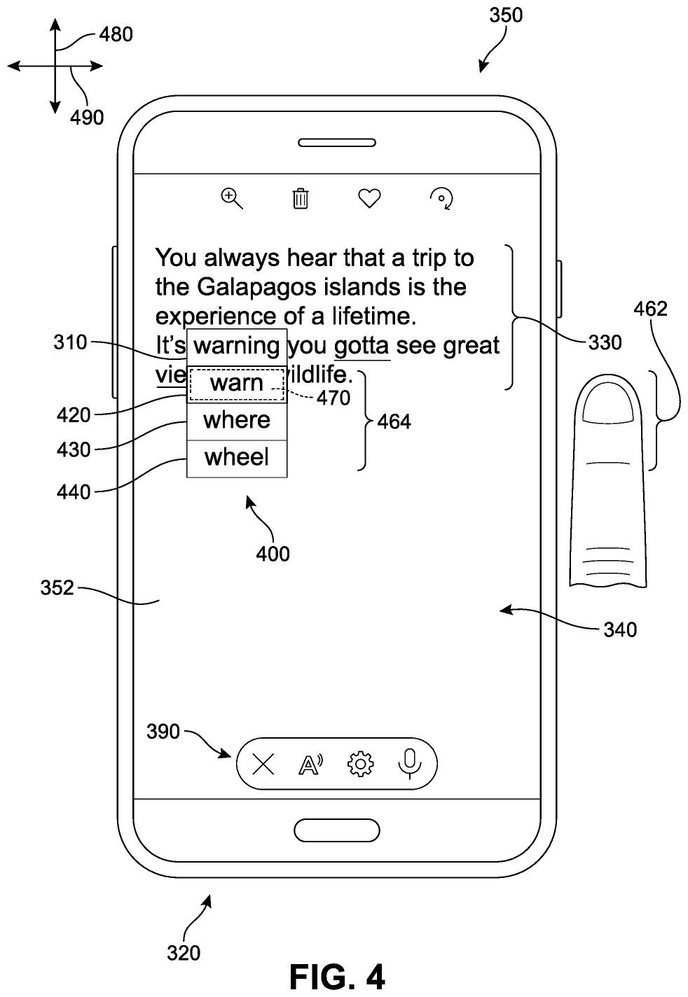

Referring next to FIG. 4, when a user selects the first term 310 or otherwise indicates a desire to view tools and tasks associated with the selected first term 310, the system may interpret the action as another triggering event. In this case, in response to the triggering event, the client application 352 displays a native control in the form of a suggestions menu 400, listing a plurality of options that may be related to the user's specific selected content or the fact that any content has been selected. In the example of FIG. 4, the native control is presented as a graphical UI (GUI). While the GUI presented is shown as a drop-down menu anchored to the selected first term 310 here, in other implementations, the native control can include any other type of user interface such as a pop-up window, a dialog box or window, a window extending from another portion of the main (application) user interface, or other application communication or presentation means. It should be understood that while in FIG. 4 the suggestions menu 400 is overlaid on the client application's main interface at a specific location, this position is shown only to underscore the relationship of the options of the suggestions menu 400 with the first term 310. However, it should be understood that in other implementations, the suggestions menu 400 may be displayed or generated anywhere else on the screen(s) associated with the client's device, including spaced apart from the first term 310 or even on a periphery of the client application 352.

In the specific example shown in FIG. 4, the suggestions menu 400 includes a series or plurality of menu options (“options”). In some implementations, the suggestions menu 400 can include one or more options normally provided when the triggering event is registered by the system (i.e., regardless of whether a content element selection has been made) such as but not limited to “Cut”, “Copy”, “Paste”, and other such options. However, in other implementations, only options related to the specific content element selection may be provided or offered. In FIG. 4, it can be seen that the menu, extending from the first term 310, includes a first content option (“first option”) 420 labeled “warn”, a second content option (“second option”) 430 labeled “where”, and a third content option (“third option”) 440 labeled “wheel”. The first option 420 is pre-selected as a potential target, as represented in this drawing by a dotted line surrounding the first option 420. Other implementations can indicate the currently targeted selection by any other types of visual indicators. For example, the content option can be labeled or identified by any other type of alphanumeric text or symbols. In other implementations, any other alphanumeric text, symbols, or graphics may be displayed in conjunction with the selection.

As noted earlier, interacting with menu options can be challenging for users of devices with smaller screens. In this example, the suggestions menu 400 is relatively small and presented via an already small device screen. For purposes of reference, an average user may have a ‘contact surface’ (e.g., region of a human finger making contact with the touchscreen) that extends across a first distance 462. When this contact surface distance 462 is compared to the surface area corresponding to the suggestions menu 464, it can be seen to encompass multiple options. Thus, were a user to simply proceed with attempting to press and contact the portion of the display corresponding to the desired option, the likelihood of an erroneous selection is relatively high. For example, the user may attempt to select the first option 420, but instead find they have selected the second option 430, or the third option 440. As a result, they have to ‘undo’ the previous submission and struggle to reposition the selection target to the desired option before trying again. In another example, the user may unintentionally tap on the original first term 310, thereby dismissing the menu, and be made to tap the first term 310 again to have the options re-appear. These types of selection, reselection, and undo processes are frustrating and time-consuming, and can discourage the user from further using a client application.

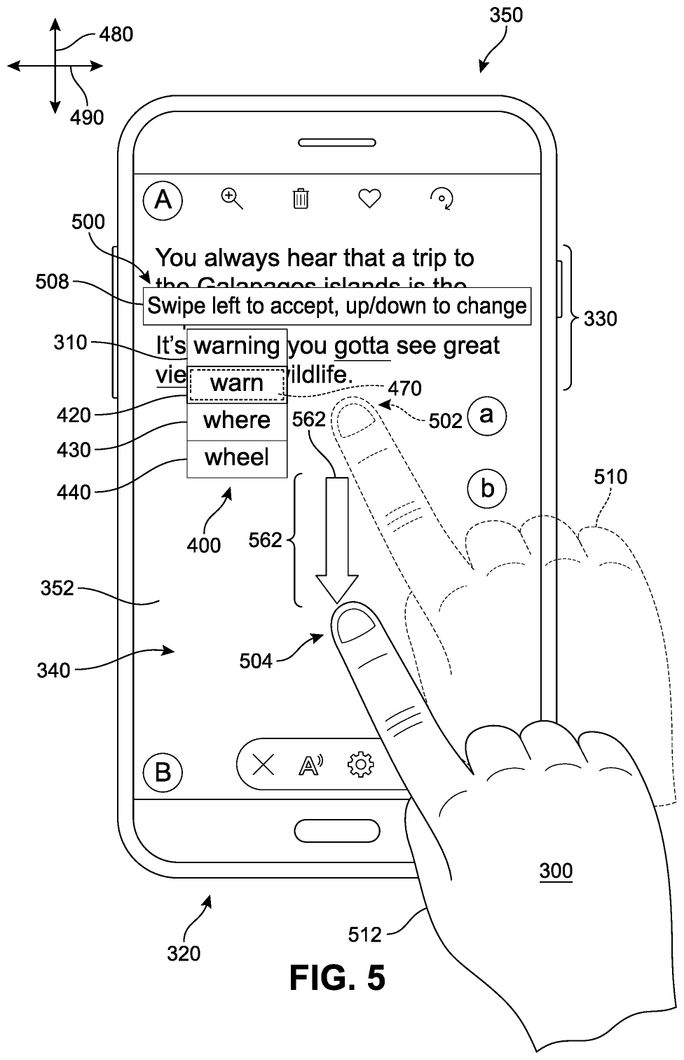

As noted earlier, in different implementations, the system can include provisions for facilitating a user's interaction experience with small displays. Referring next to FIG. 5, in different implementations, during various user interactions with the client application 352, the client application 352—either as originally installed, updated, upgraded, or via a plug-in (or other software component that adds the disclosed feature to an existing program)—may offer the user an opportunity to view additional navigation options associated with particular portions of the content. In FIG. 5, in response to the user's actuation of the first term 310 and the appearance of the suggestions menu 400, the system offers an alternate navigation process by which the second user 300 can move efficiently and reliably from one option to another. In some implementations, as shown here, this opportunity can be made automatically available once a specific triggering event occurs (e.g., actuation of the first term 310 or other option), while in other implementations, the user may be able to access and activate the feature of this navigational tool from another menu or shortcut at any time.

As one example, in some implementations, the system can be configured to receive particular touch gesture inputs as corresponding to specific navigational requests associated with a ‘prime’ menu (i.e., a menu or other set of options that, while provided or shown, temporarily disables or blocks inputs from affecting content outside of that menu). In this case, the prime menu is the suggestions menu 400, and the content outside of that menu becomes disabled or unaffected by user inputs during this time, such as remaining visible aspects of the second interface, including as the client application toolbar(s) described with respect to FIGS. 2 and 3 and/or other previously actuatable aspects of the first content 330.

Thus, in different implementations, once a touch gesture input mode or configuration 500 is activated, the system can be configured to respond to any touch inputs as being directed to the currently offered prime menu. In some implementations, the user may be notified by a message 508 or other guide that the touch gesture input configuration 500 is now ‘in session’ or currently active, and/or information as to how to operate the navigation provided by the touch gesture input configuration 508. In this example, the message 500 states “Swipe left to accept, up/down to change” indicating that a touch swiping gesture in either a substantially upward or substantially downward direction—relative to the orientation of the application—will allow the user to move between options (change the presently selected option), while a touch swipe gesture in a leftward direction can confirm, accept, or otherwise actuate the currently selected option (target). The second user 300, for purposes of illustration, is shown swiping in a downward direction 560. In other words, the user maintains contact on the device display 340 while they move from a first contact position 502 associated with an initial or starting user position 510 to a second contact position 504 associated with a final or end user position 512. Furthermore, it can be seen that the downward direction 560 is approximately parallel to a first axis 480, and approximately perpendicular to a second axis 490, where the first axis 480 and the second axis 490 are orthogonal to one another. Throughout this application, the first axis 480 may also refer to a “vertical axis” and the second axis 490 may also refer to a “horizontal axis”.

It should be understood that, in different implementations, the relative distances that may be traveled between first contact position 502 and the second contact position 506 to register as a downward swipe gesture do not affect the response by the system. Thus, a distance 562 may extend from a topmost portion (e.g. point “A”) of the touchscreen to a lowermost portion of the touchscreen (e.g., point “B”), or the distance 562 may only cover a brief distance (e.g., between points “a” and “b”), or any other distances across the screen, while resulting in the same discrete response by the system. In other words, other than implementations in which a minimum swipe distance is required to ensure an adequate contact distance for verifying a swipe has occurred, a swipe of any magnitude or length or distance will lead to the same discrete unit of change. Thus, a long swipe or a short swipe can both lead to a discrete scroll-step or move between one target option and a next target option. However, in other implementations, the system settings may be adjusted such that a particular distance range (e.g., a swipe extending between point “A” and point “b”) can correspond to a single discrete unit of change, while a relatively longer swiping distance (e.g., extending between point “A” and point “B”) can be interpreted by the system as a request to move two (or more) units away from the current target.

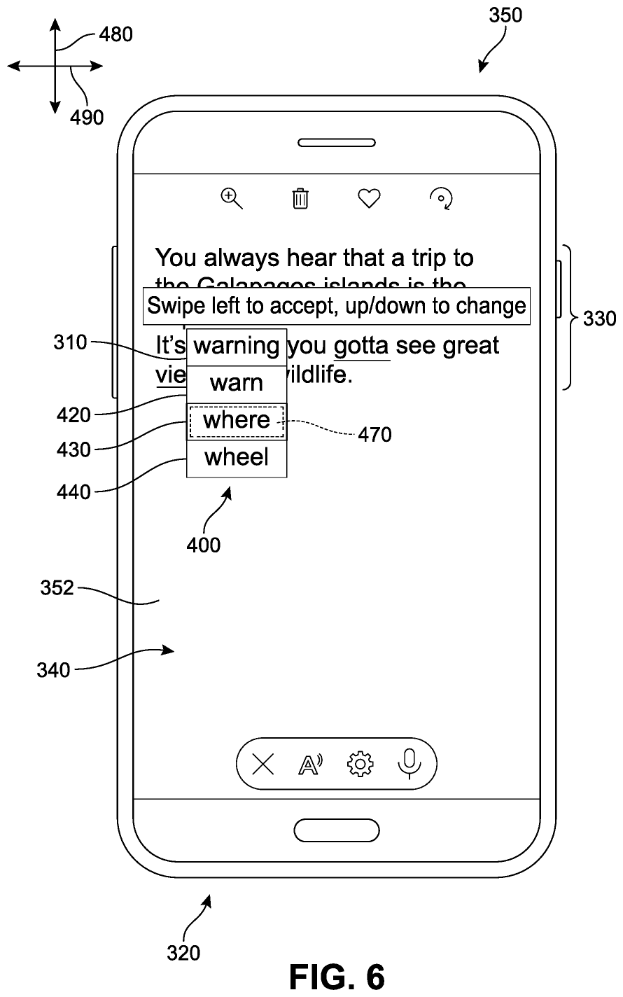

Referring now to FIG. 6, it can be seen that the system has interpreted the user input depicted in FIG. 5 as corresponding to a request for navigation between the first option 420 and the second option 430. In response, the system executes a task in which the visual indicator 470 is moved from the first option 420 to the second option 430, alerting the user that their input has been received and confirming that a new option has become the target. In this case, the second option 430 is directly below and adjacent to the first option 420. In other words, the options are arranged in sequence that extends in a direction approximately parallel to the first axis 480. In other words, in different implementations, the navigation command direction can be aligned with the same axis along which the options are arranged (e.g., upward and/or downward swipes for a menu with options arranged along a vertical axis, and a leftward and/or rightward swipe for a menu with options arranged along a horizontal axis). This can increase the intuitiveness with which the user interacts with the interface and the provided navigation command input types.

It should be understood that the movement between one option and another in itself is an execution of a navigational task, whereby visual indicators are moved or changed to represent the change in position on the display, but no further execution of application-based tasks or productivity events are occurring. In other words, this navigational event is generally akin to a mouse cursor moving between a first position and a second position on a screen. Upon reaching the second position, the visual indicator may be approximately akin to a mouse ‘hovering’ over an option prior to the user providing an input (such as a click or tap) that would confirm the selection of that option. The representations of such movements are important and necessary for the user to remain aware of their own interactions in the interface as well as ensure accurate target selections. Thus, in this case, the change in location and/or appearance of the visual indicator as the user moves down (or up) the menu options is an important aspect for the user to keep track of their navigation.

In some implementations, the second user may repeat the general input type depicted in FIG. 5 any number of times to navigate through the suggestions menu 400. In cases where a longer list (i.e., more than three options) are offered, there may be multiple swipes to reach the desired selection. In another implementation, upon reaching the bottom-most option (here, third option 440 “wheel”), another downward swipe by the user can result in a wrap-around effect in which the next option becomes the first option in the menu. In one other implementation, once the bottom-most option is attained, further downward swipes will produce no appreciable change, other than perhaps a blinking indication reminding the user they have reached the end of the list, as the last option remains selected. Similar effects can occur if the user reaches the uppermost or first option on the menu.

Returning briefly to FIG. 5, it is important that the reader understand that although the second user 300 was only shown swiping in a downward direction 560, the same type of input process is available for moving ‘back’ or returning to a previous or upper option. In other words, the user can provide a touch swipe gesture in an upward direction that is substantially opposite to the downward direction 560. As an example, were the user to maintain contact with the device display 340 as they move from the second contact position 504 that will now correspond to an initial or starting user position to the first contact position 502 that will now correspond to a final or end position, this would initiate an input corresponding to a request for navigation from the second option 430 back to the first option 420. In addition, similar to what was discussed above for the downward swipes, in some implementations, the second user may repeat such upward swipes any number of times to navigate through the suggestions menu 400, or move up and down as desired until the user decides on a final target.

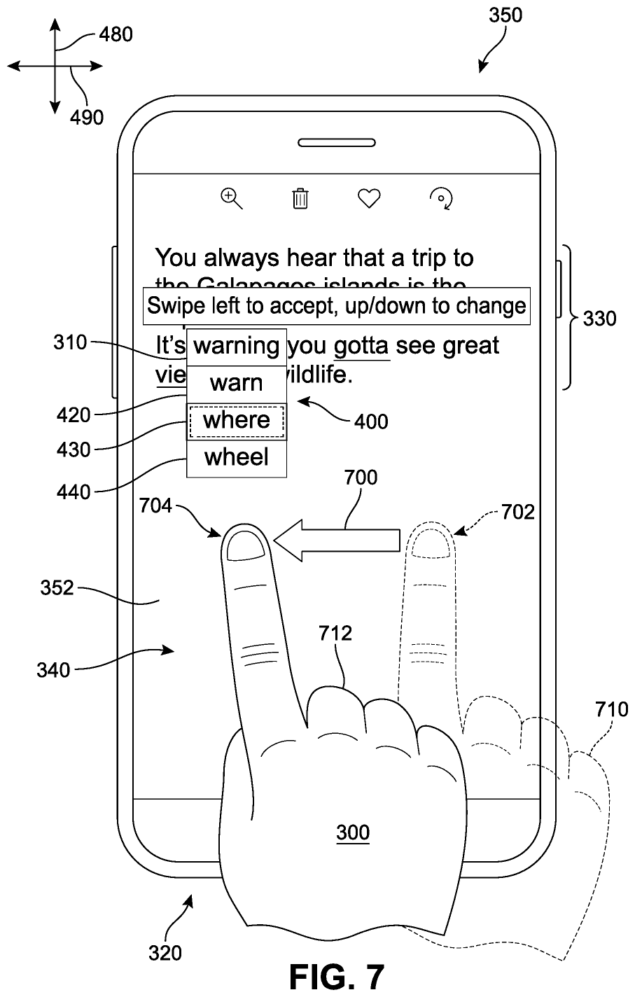

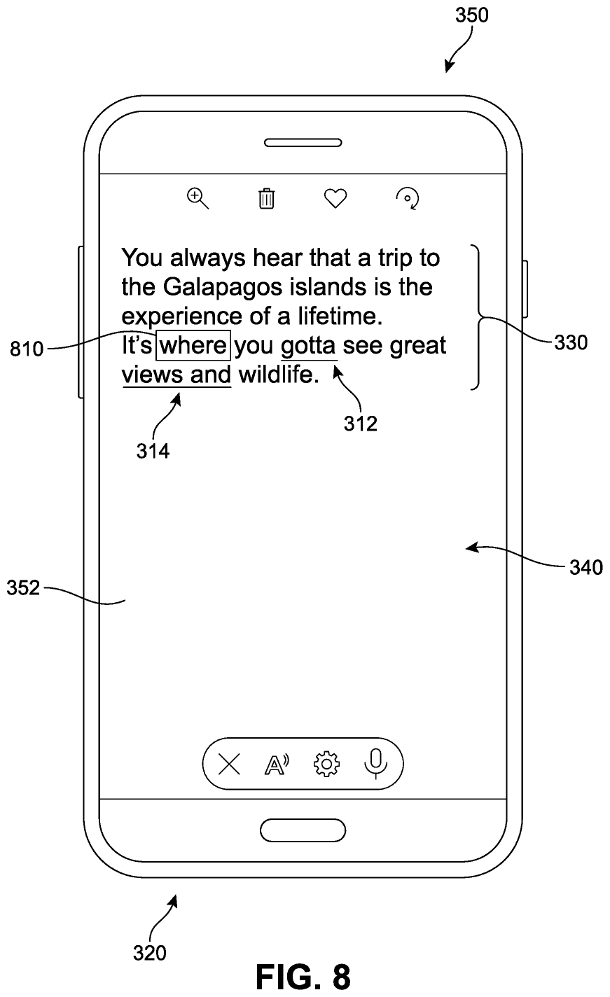

Once a user determines the desired option has been acquired, an alternate or different type of touch gesture input may occur to confirm (i.e., submit or actuate) such a selection. For example, in FIG. 7, the second user 300 is shown swiping in a leftward direction 700. In other words, the user maintains contact on the device display 340 while moving from a third contact position 702 associated with an initial or starting user position 710 to a fourth contact position 704 associated with a final or end user position 712. Furthermore, it can be seen that the leftward direction 700 is approximately parallel to the second axis 490, and approximately perpendicular to the first axis 480. It should again be appreciated that, in different implementations, the relative distances that may be traveled between third contact position 702 and the fourth contact position 704 to register as a leftward swipe gesture do not affect the response by the system, similar to that approach discussed above with respect to FIG. 5. In general, a swipe of any magnitude or length or distance will lead to the same response by the system, whereby the selected second option 430 “where” is now actuated (accepted), thereby automatically triggering a change in content or other action or task that corresponds to such a selection, as shown in FIG. 8.

In different implementations, the system can also be configured to automatically disable or dismiss the gesture-based navigation process once the menu for which the feature was activated is released (for example by selection of an option). In FIG. 8, the suggestions menu 400 shown previously has been removed, and the first content 330 is displayed clearly again (i.e., unobstructed by the superimposition of other options). However, in other implementations, the suggestions menu need not have been directly overlaid on the region of the interface including the textual content, and the removal of the suggestions menu returns the interface to its (approximately) previous condition reflected in FIG. 3. The user can observe the resulting change that occurred in response to his or her selection. In this case, the term “warning” has been replaced by the term “where”. For purposes of clarity, the modified portion is associated with another visual indicator 800 (here, a boundary box) to provide feedback to the user confirming that the requested change to the content was made. The visual indicator may be temporary, and shown only for a brief duration. In other implementations, the change may be made without any corresponding visual indicator or alert. The remaining potential ‘errors’ are still available, and user interaction with these (e.g., second term 312 and/or third term 314) can trigger the display of another suggestions menu that may also automatically enable or activate the navigational process described herein.

Returning briefly to FIG. 7, it is important that the reader understand that although the second user 300 was only shown swiping in a leftward direction 700, and the message 508 indicated “left” was the direction corresponding to acceptance and submission of the option, the command input configuration can vary to produce the same result. As an example, the message 508 may instead have indicated “Swipe right to accept”, and the user in FIG. 7 could swipe in a rightward direction that is substantially opposite to the leftward direction 700 because of the system configuration. In other words, the user would instead move from the fourth contact position 704 (that would then be the initial position) to the third contact position 702 (that would then be the final position). Alternatively, the direction that is opposite to the navigation command that has been configured to register as an acceptance (submit) instruction can correspond to another, different input-response pairing, such as (but not limited to) an “undo” or de-select function, or a request to view further menu options or settings. In another implementation, either (or both of) a rightward or a leftward directed swipe input could correspond to a request to accept the currently targeted option. These responses or functions can be adjusted by the user and/or can be determined by the system.

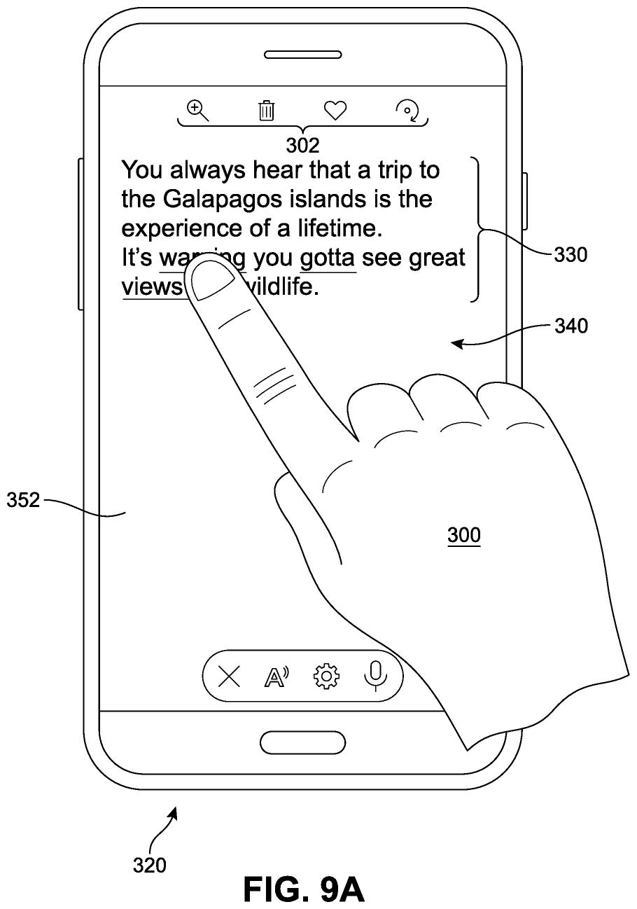

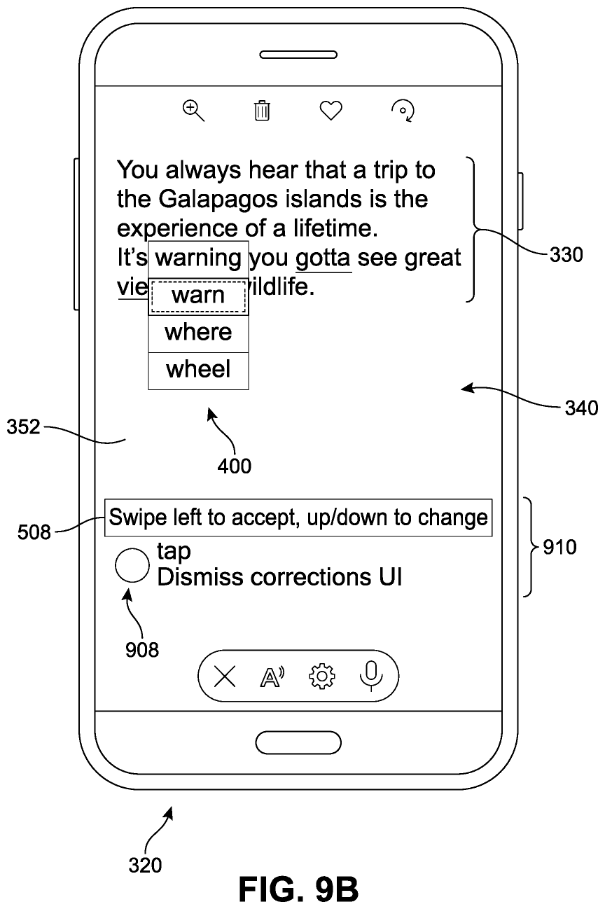

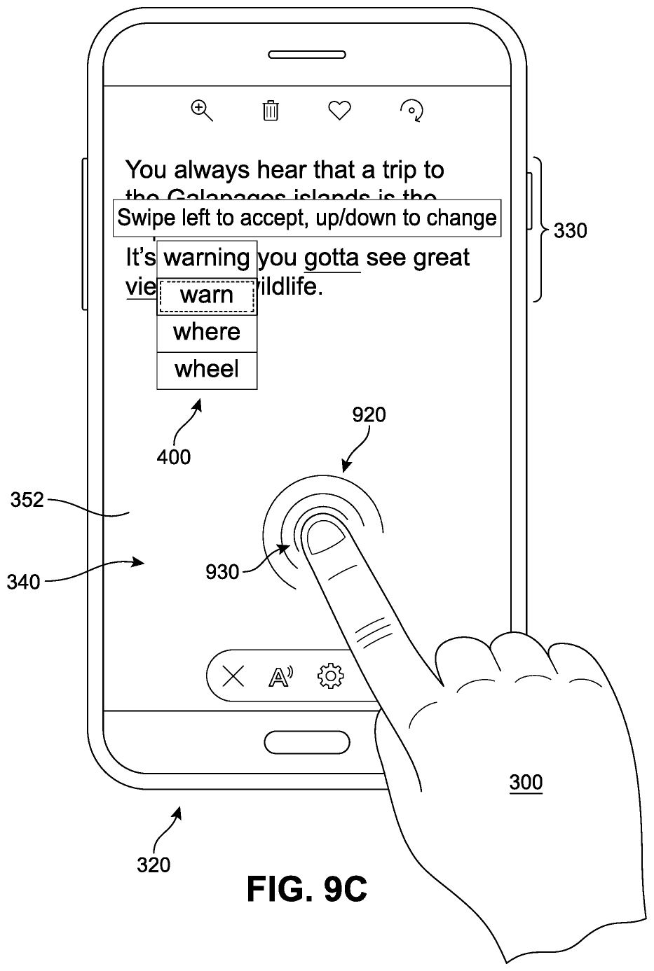

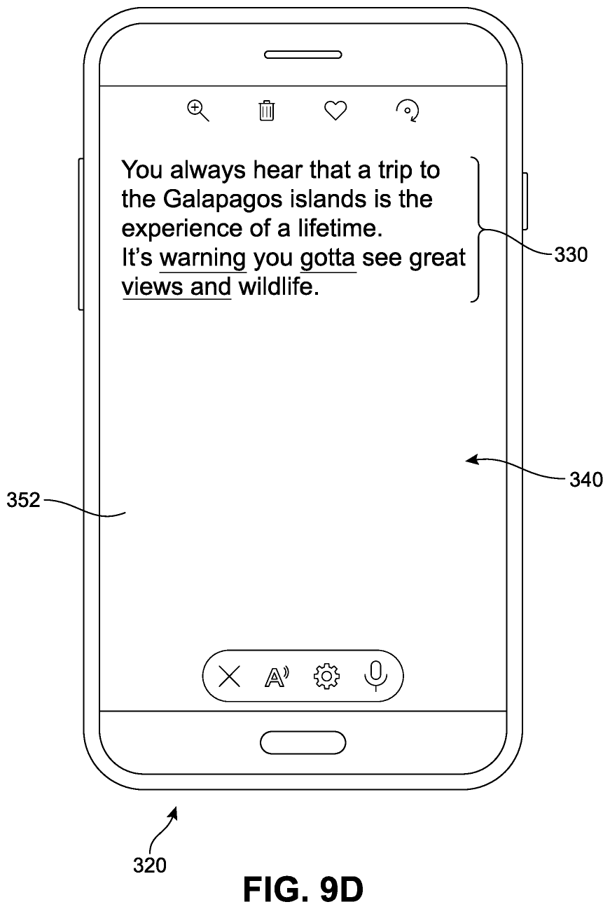

In different implementations, the system may include provisions for facilitating a user-initiated dismissal of the touch gesture based navigation as desired. One example is shown in FIGS. 9A-9D. In FIG. 9A, the second user 300 selects an actuatable term from the first content 330. As shown in FIG. 9B, this selection causes a display of options associated with the term via suggestions menu 400. In some implementations, this type of selection in which a drop-down menu or other smaller GUI is presented can also automatically activate or enable gesture based navigation, as represented by the display of a navigational notification 910. The navigational notification includes both the message 508 and an exit message 908, which informs the user that a touch ‘tap’ will “Dismiss corrections UI”. Thus, in some implementations, a tap to the display screen can be received by the system as a request to exit or dismiss the proffered options and disable the touch-swipe gesture input mechanism associated with the options. This is shown in FIG. 9C, where the second user 300 taps 920 upon a region 930 of the touchscreen, resulting in a dismissal of the suggestions menu 400, as shown in FIG. 9D. The user can then easily reject the proffered options (here no modification was made to the first content 330) and continue with their review or other work. It may be appreciated that, in different implementations, the tap can occur anywhere along the surface of the touchscreen. In other words, the first region 930 need not be limited to a region including the suggestions menu 400 nor must the first region 930 be near or on a specific portion of the screen. By allowing the user to provide a dismissal input simply by tapping anywhere on the screen, instead of having to tap a limited region of the screen or specific button or graphical element, the user can interact more efficiently and confidently on devices with smaller form factors.

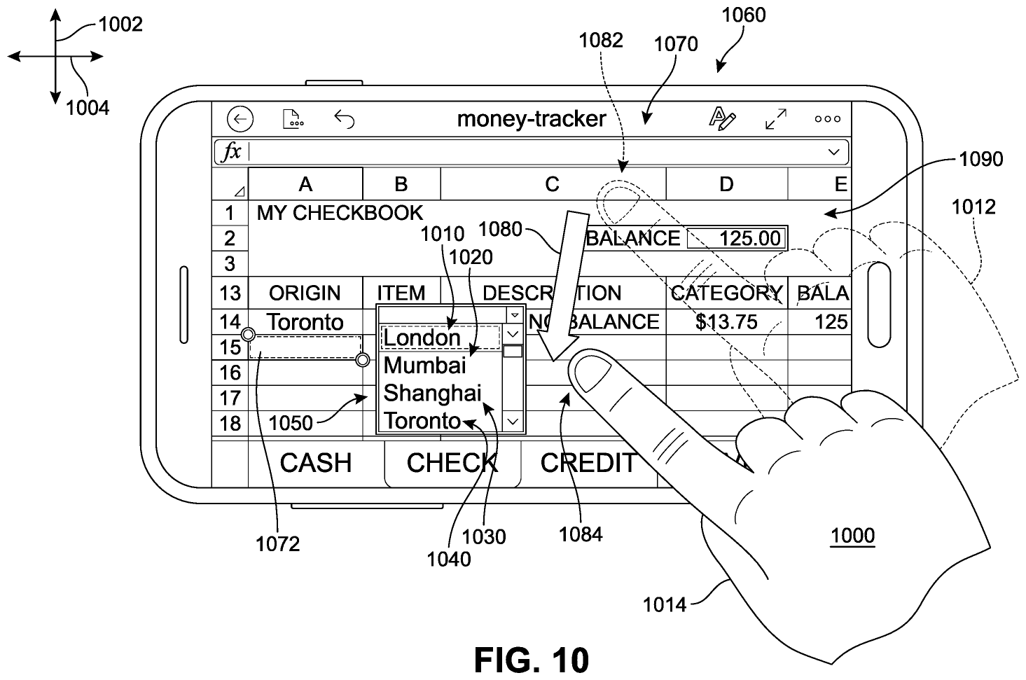

Turning now to FIGS. 10-12, an additional example of an implementation of the proposed systems is presented. In FIG. 10, a third user 1000 is (represented by a hand) is accessing a spreadsheet or database-type client application (“client application”) 1070, as represented by a third user interface (“third interface”) shown on a device display of a second device 1060. While the client application 1070 comprises a simplified spreadsheet program displaying a plurality of cells and corresponding content in FIG. 10, in other implementations, the client application 1070 can represent a version of Microsoft Excel®, or another data processing program, such as Apache OpenOffice®, LibreOffice®, Google Docs Spreadsheet®, Scoro®, Numbers for Mac®, Spread32®, Gnumeric®, Birt Spreadsheet®, Zoho Sheet®, and other data analysis programs. In addition, in still other implementations, the client application may include any other software applications within the Microsoft Office Suite® or array of Microsoft® products as well as any non-Microsoft® based applications for modifying and/or working with electronic content.

In this example, a second electronic content (“second content”) 1090 has been generated or otherwise obtained and is being shown to the user. Furthermore, during interaction with a portion of the spreadsheet represented by a field or cell 1072, the third user 1000 has triggered a presentation of a type of in-cell drop down list 1050 that offers a plurality of item choices from which to fill or enter into the cell 1072, including a first item 1010 (“London”), a second item 1020 (“Mumbai”), a third item 1030 (“Shanghai”), and a fourth item 1040 (“Toronto”).

In this specific example, the ‘prime’ menu is list 1050, and the third user 1000 is shown swiping in a downward direction 1080. In other words, the user maintains contact on the device display while moving from a first contact position 1082 associated with an initial or starting user position 1012 to a second contact position 1084 associated with a final or end user position 1014. Furthermore, it can be seen that the downward direction 1080 is generally parallel to a first axis 1002, and approximately perpendicular to a second axis 1004, where the first axis 1002 and the second axis 1004 are orthogonal to one another. In this case, although the mobile device is oriented horizontally rather than vertically (as shown in FIGS. 2-8), the first axis 1002 will refer to a “vertical axis” and the second axis 1004 refers to a “horizontal axis”, where the axes are labeled in accordance with the display context of the client application.

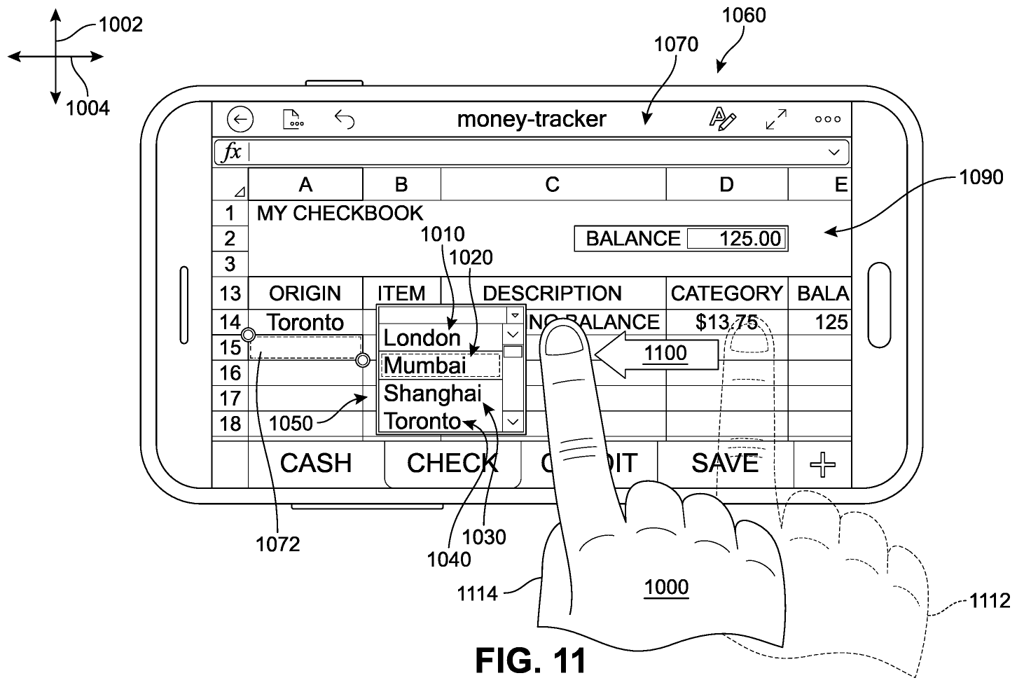

Referring now to FIG. 11, it can be seen that the system has interpreted the user input depicted in FIG. 10 as corresponding to a request for navigation between the first item 1010 and the second item 1020. In response, the system executes a task in which a visual indicator is removed from the first item 1010 and a visual indicator is now associated with the second item 1020, informing the user that their input has been received and confirming that a new item has become the target. In this case, the second item 1020 is directly below and adjacent to the first item 1010. In other words, the items are arranged in sequence that extends in a direction approximately parallel to the first axis 1002. As noted earlier, in some cases the movement between one option and another in itself is a representation of an execution of a navigational task. Although not required, the change in location of visual indicators can help the user keep track of the navigation that has occurred. In some implementations, the second user may repeat the general input type depicted in FIG. 10 any number of times to navigate through the other items in list 1050. It is important that the reader understand that although the third user 1000 was only shown swiping in a downward direction 1080, the same type of input process is available for moving ‘back’ or returning to a previous or upper option, as described earlier.

In addition, it may be observed that the downward direction 1080 is not exactly or completely parallel to first axis 1002 (i.e., may be diagonal), but the system nevertheless accepts the input as an appropriate request for a navigation along the items in the list. In other words, in different implementations, the systems described herein may be configured to accept a range of swipe orientations that are generally or primarily aligned with particular axis to a predefined degree as appropriate navigation inputs. Thus, with reference to the various types of swipe based navigation inputs, it should be understood, the terms “substantially downward” or “substantially upward” are understood to apply to a stroke in which the start and end points have a change in x values that is less than the change in y values, where the x-axis is represented by the second axis 1004 (or second axis 490 of FIG. 4) and the y-axis is represented by the first axis 1002 (or first axis 480 of FIG. 4). Similarly, the terms “substantially leftward” or “substantially rightward” may be understood to apply to a stroke in which the start and end points have a change in y values that is less than the change in x values.

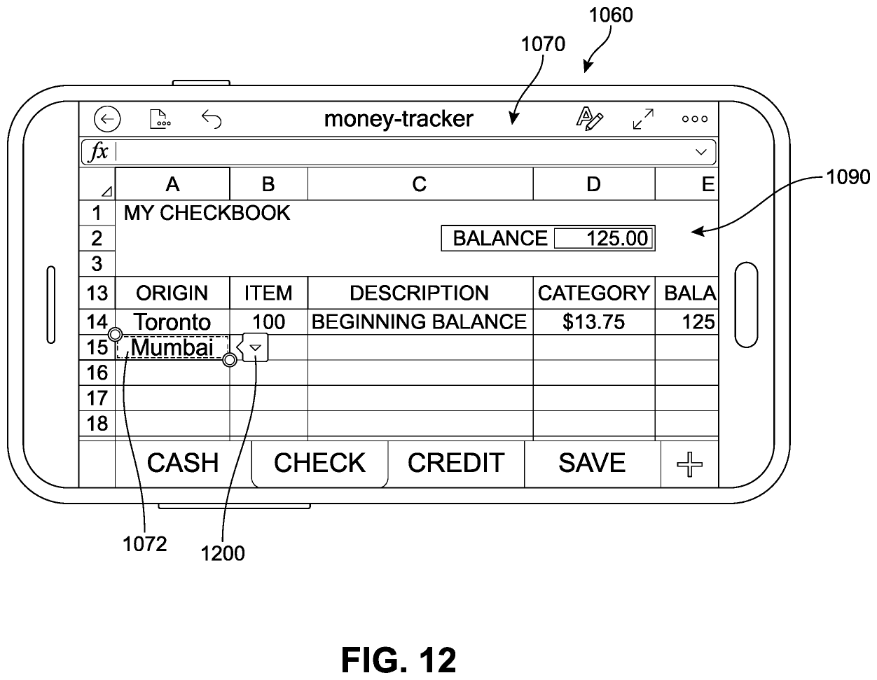

In FIG. 11, the third user 1000 is also providing a next touch gesture input to confirm their selection of second item 1020 by a swipe in a leftward direction 1100. In other words, the user maintains contact on the device display while moving from a third contact position 1102 associated with an initial or starting user position to a fourth contact position 1104 associated with a final or end user position. Furthermore, it can be seen that the leftward direction 1100 is approximately parallel to the second axis 1004, and approximately perpendicular to the first axis 1002. Finally, in FIG. 12, the system automatically disables the gesture-based navigation process once the list for which the feature was activated is dismissed (e.g., via selection of the second item 1020). In FIG. 12, the cell 1072 has been filled by the selected second item “Mumbai”, and the user can continue working within the spreadsheet. If a return to the list is desired an actuatable indicator 1200 is visible near the cell 1072 for reinitiating the list display and automatically re-enabling the navigational tools described. In other implementations, a wide range of other possible menus or options that would otherwise be difficult to interact with can be readily navigated by a touch-based gesture process provided herein.

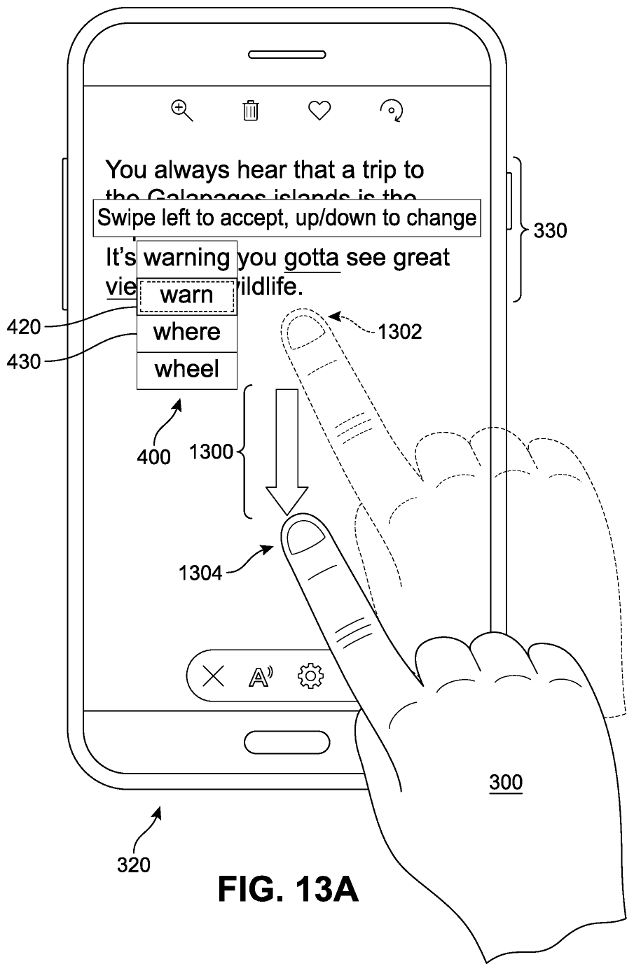

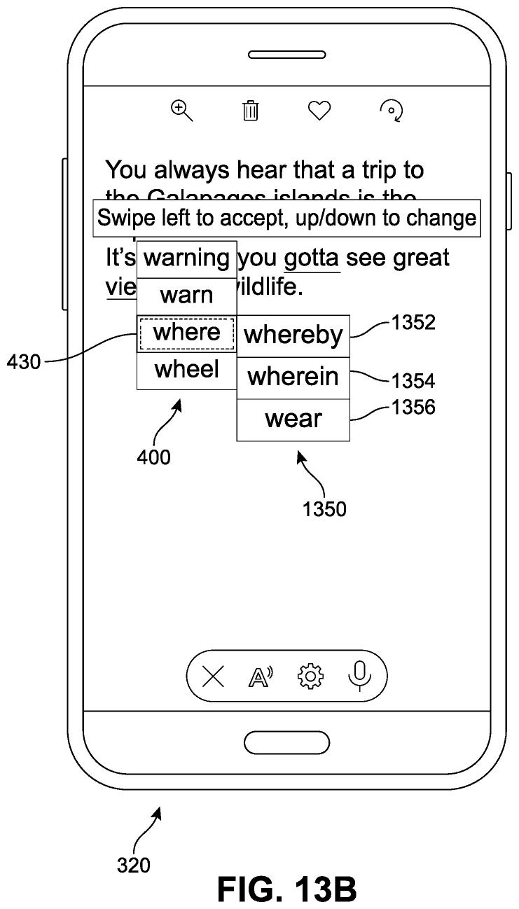

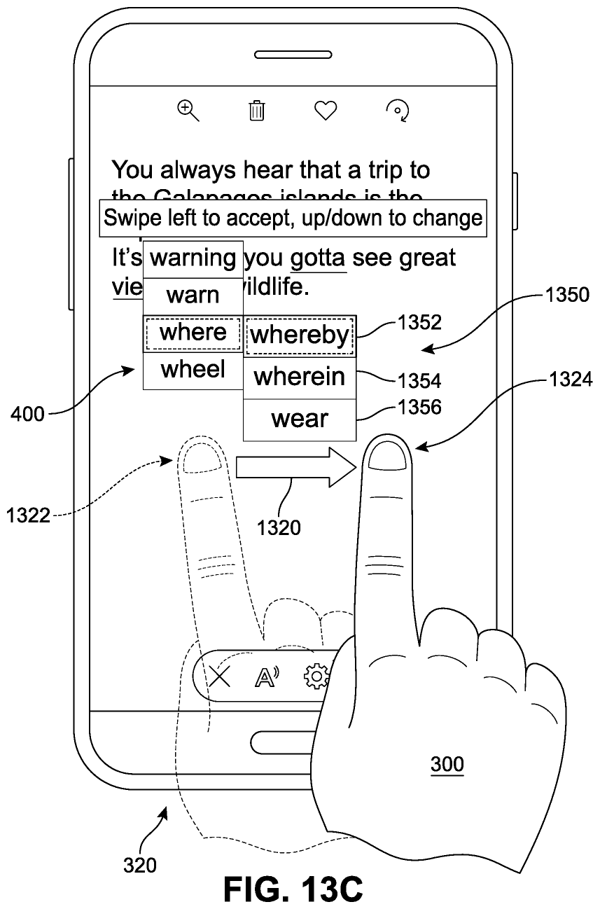

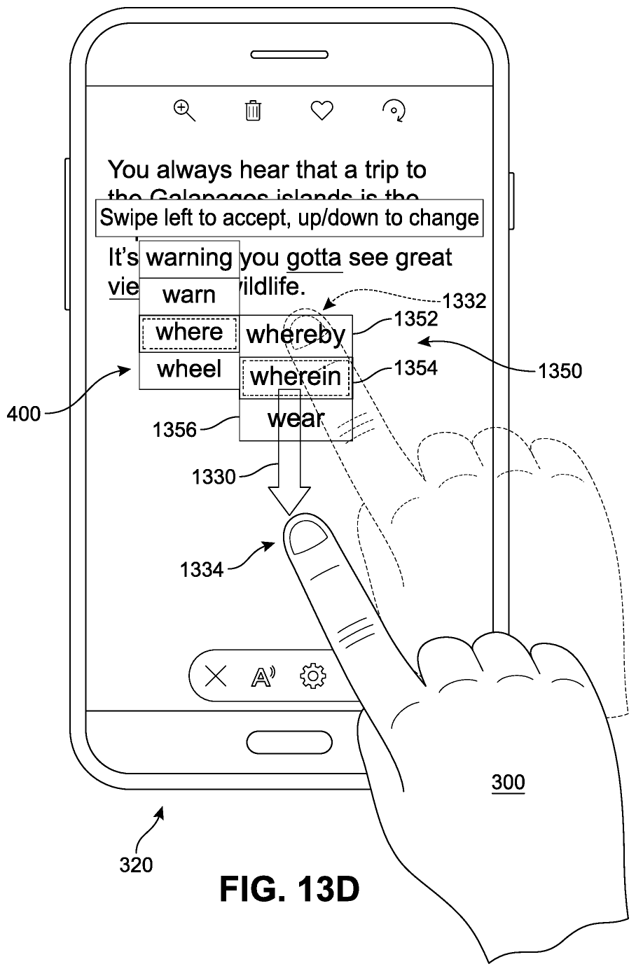

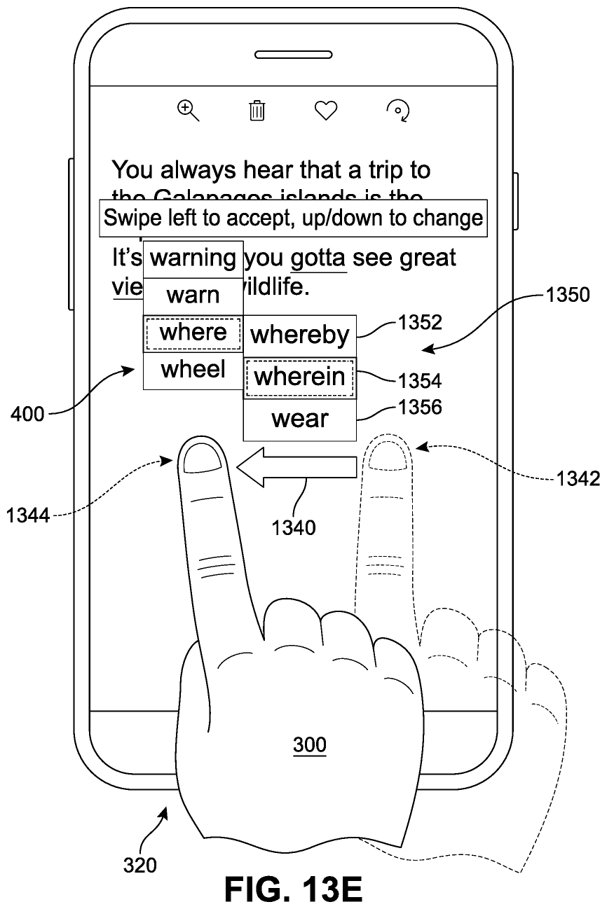

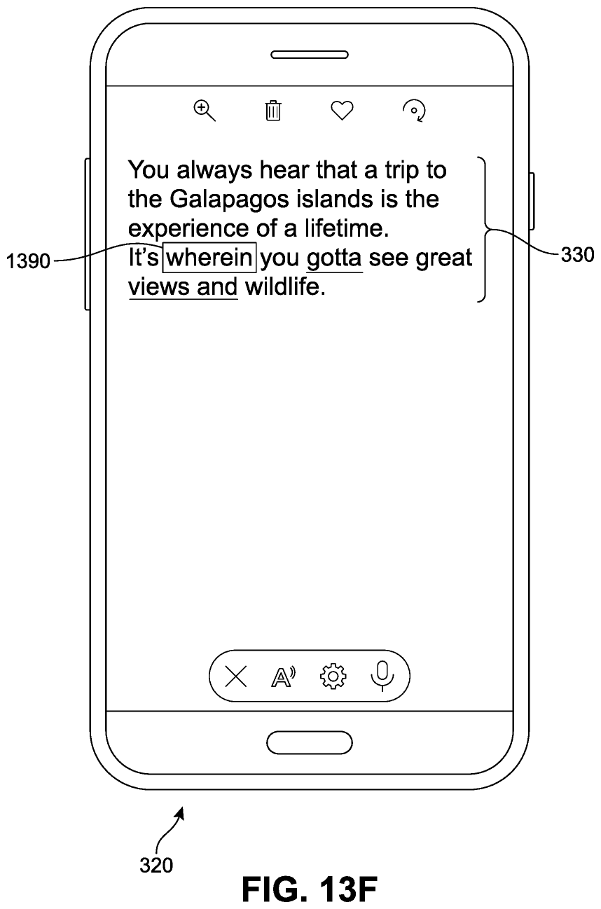

It can further be understood that in some implementations, navigation to a menu option can sometimes trigger the presentation of additional ‘cascading’ menus that may also benefit from the proposed systems. One example is now shown with reference to a sequence of drawings in FIGS. 13A-13E. In FIG. 13A, the second user 300 of FIGS. 2-8 is again depicted, interacting with a fourth interface via second device 320. In this case, the second user 300 provides a first input corresponding to a navigation between the first option 420 and the second option 430, where the first input is a first swiping touch gesture in a first direction 1300 (here a primarily downward direction), moving from a first position 1302 to a second position 1304. Accordingly, the visual indicator moves from the first option 420 to the second option 430 in response to the first input. In FIG. 13B, it can be seen that in this case, the fourth interface presents another menu, herein referred to as a child, cascading, or secondary menu 1350. (For purposes of context, the navigation menu 400 will be understood to serve as the primary or parent menu.) In this example, the secondary menu 1350 includes three items, including a first cascading option 1352, a second cascading option 1354, and a third cascading option 1356.

In other words, in some implementations, the client applications can offer a cascading-type menu interface with one or more options that, when selected, are configured to display or otherwise offer submenus or additional (secondary) options, generally related to the previous selection. These additional options can be presented off to one side of the primary ‘main’ menu, as one example, or can be presented elsewhere on the display, or even overlaid on a portion of the primary menu. In some implementations, such cascading menu interfaces can be configured to show different submenus or options in response to the item selected in the interface. Furthermore, additional (e.g., tertiary) cascading menus can extend from the secondary menu, and so forth.

In FIG. 13C, the second user 300 provides a second input corresponding to a navigation between the primary, navigation menu 400 and the secondary menu 1350, where the second input is a second swiping touch gesture in a second direction 1320 (here a primarily rightward direction), moving from a third position 1322 to a fourth position 1324. Accordingly, the visual indicator moves from the second option 420 to the first cascading option 1352 in response to the second input. Thus, a user is able to easily transition or move between multiple menus or options offered on the device display by the touch gesture navigational mechanisms described herein. In FIG. 13D, the second user 300 provides a third input corresponding to a navigation from the first cascading option 1352 to the second cascading option 1354, where the third input is a third swiping touch gesture in a third direction 1330 (here similar to first direction 1300 of FIG. 13A, or a primarily downward direction), moving from a fifth position 1332 to a sixth position 1334. Accordingly, the visual indicator moves from the first cascading option 1352 to the second cascading option 1354 in response to the third input.

In FIG. 13E, the second user 300 has determined that the second cascading option 1354 is the desired replacement term in the first content 330, and provides a fourth input corresponding to an acceptance of the current target, where the fourth input is a fourth swiping gesture in a fourth direction 1340 (here a primarily leftward direction), moving from a seventh position 1342 to an eighth position 1344. In response, as shown in FIG. 13F, the term “wherein” 1390 has replaced the previously shown term “warning” in the first content 330. Thus, in different implementations, the swiping gestures can provide users with a simple and effective input mechanism by which to interact with small or otherwise unwieldy selectable content or options. It can be appreciated that other touch-based inputs can be used to facilitate these types of menu paradigms. For example, returning to FIG. 13D, were the user to instead wish to dismiss the secondary menu 1350 prior to making a selection (i.e., and revert or return to the primary navigation menu 400), they may simply tap the screen, as described earlier with respect to FIGS. 9A-9D, and the secondary menu 1350 may disappear, leaving only the primary menu. Another (second) tap can be submitted by the user as a request to then dismiss the primary menu without making a selection if so desired.

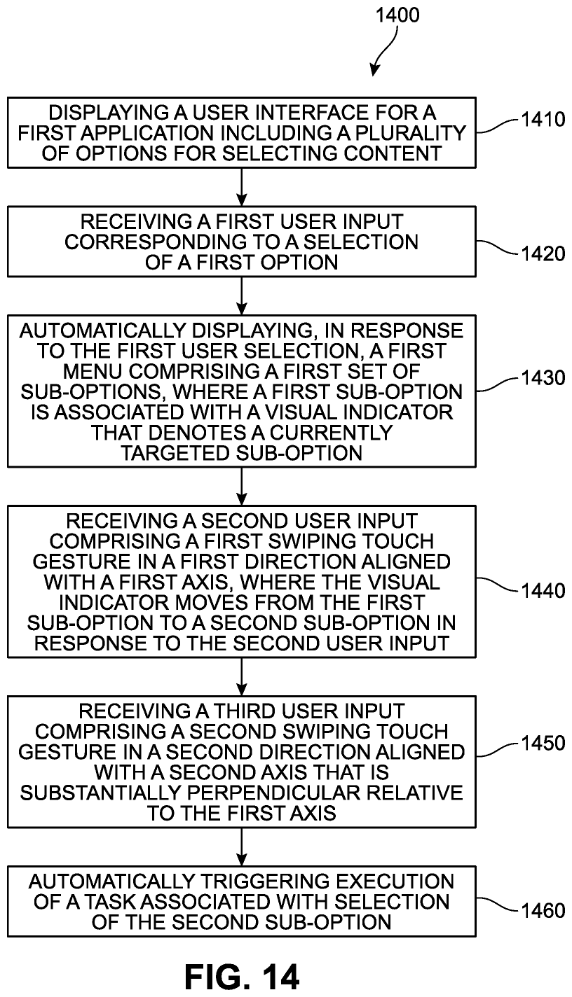

FIG. 14 is a flow chart illustrating an implementation of a method 1400 of navigating options in a menu using the disclosed system. A first step 1410 includes displaying, on a client device, a first user interface for interacting with a software or other client-based or client-operated (e.g., can be web-based but accessed via the client device) application (“first application”). The first user interface includes a plurality of actuatable options for selecting content that are available via the first application. The plurality of actuatable options including a first option. A second step 1420 includes receiving, via the touch-screen display, a first user input corresponding to a selection of the first option. For example, the user may tap to select, use voice-command(s) to select, or may use a leftward swipe to select. A third step 1430 includes automatically displaying, in response to the first user selection, a first menu. The menu can include one or more options—herein referred to as a first set of sub-options. For this example, the first set of sub-options includes a first sub-option, a second sub-option, and a third sub-option. In addition, the sub-option that potentially represents the user's forthcoming selection (is the currently targeted selection) can be associated with a visual indicator that distinguishes the current target from the remaining options so that the user can remain cognizant of the position of the selector.

A fourth step 1440 includes receiving, via the touch-screen display, a second user input corresponding to a navigation between the first sub-option and the second sub-option. In different implementations, the second user input comprises a first swiping touch gesture in a first direction aligned with a first axis (e.g., an downward swipe, an upward swipe, a leftward swipe, a rightward swipe). Furthermore, the visual indicator can be configured to move from the first sub-option to the second sub-option in response to the second user input to confirm the input was received and interpreted as a request to change the currently targeted option. A fifth step 1450 includes receiving, via the touch-screen display, a third user input corresponding to a selection (i.e., actuation) of the second sub-option. In different implementations, the third user input comprises a second swiping touch gesture in a second direction aligned with a second axis that is substantially perpendicular relative to the first axis. Thus, if the previous, first swiping gesture was approximately or roughly parallel to a horizontal axis, the second swiping gesture could be approximately or roughly parallel to a vertical axis extending perpendicular to the horizontal axis; alternatively, if the first swiping gesture was approximately or roughly parallel to a vertical axis, the second swiping gesture could be approximately or roughly parallel to the horizontal axis. In a sixth step 1460, the method can include automatically triggering execution of a task associated with the selection of the second sub-option.

In other implementations, the method may include additional steps or aspects. In some implementations, the first swiping touch gesture may be applied from a left side of the touch-screen display to a right-side of the touch-screen display, and the second swiping touch gesture is applied from an upper-side of the touch-screen display to a lower-side of the touch-screen display. Alternatively, the first swiping touch gesture is applied from an upper-side of the touch-screen display to a lower-side of the touch-screen display, and the second swiping touch gesture is applied from a left side of the touch-screen display to a right-side of the touch-screen display.

As another example, the first sub-option may be directly adjacent to the second sub-option on the first menu. In some cases, the first menu is positioned in a first portion of the touch-screen display and contact corresponding to the first swiping touch gesture occurs outside of the first portion. In other words, the user input does not need to rely on any touch-based input occurring directly within the space occupied by the displayed menu. In one implementation, the first application can comprise a text editor, and the first set of sub-options displays options for replacing portions of text also being displayed on the touch-screen display. Alternatively the application can be configured to present data via a spreadsheet, illustration, e-mail, file storage directory, or presentation slideshow interface, etc., and the options can allow the user to choose from options offered for specific content portions in those applications. As another example, the first user input can include a tap on the touch-screen display. Furthermore, in some implementations, the first set of sub-options can be displayed as a cascading menu extending in a direction substantially parallel to the first axis.

In different implementations, the method can also include steps of receiving, via the touch-screen display, a fourth user input corresponding to a dismissal of the first menu, and then removing, in response to the fourth user input, the display of the first menu. The fourth user input can for example comprise a tap on the touch-screen display that is outside of the first portion. In another implementation, the method can also include receiving, via the touch-screen display, a fourth user input corresponding to an undo command, and then undoing, in response to the fourth user input, the execution of the task. In some cases, the fourth user input includes a third swiping touch gesture in a third direction aligned with a second axis that is substantially perpendicular relative to the first axis that is opposite to the first direction. In some implementations, the method may further include a step of receiving, via the touch-screen display, a fourth user input that corresponds to a request for navigation from the second sub-option to the third sub-option. The fourth user input comprises a third swiping touch gesture in the first direction. In addition, the visual indicator moves from the second sub-option to the third sub-option in response to the fourth user input. In other words, the user can continue or repeat the swipe gesture to move further through the options shown. Another step can include receiving, via the touch-screen display, a fifth user input corresponding to a request for navigation from the third sub-option to the second sub-option. The fifth user input comprises a fourth swiping touch gesture in a third direction that extends in a direction substantially opposite to the first direction (e.g., upward/downward, or leftward/rightward). In addition, the visual indicator can moves from the third sub-option back to the second sub-option in response to the fifth user input.

Implementations of the present disclosure can make use of any of the features, systems, components, devices, and methods described in U.S. Patent Publication Number 2013/0067366 to Almosnino, published Mar. 14, 2014 and titled “Establishing content navigation direction based on directional user gestures”; U.S. Pat. No. 7,810,043 to Ostojic et al., granted Oct. 5, 2010 and titled “Media user interface left/right navigation”; U.S. Patent Publication Number 2008/0040692 to Sunday et al., published Feb. 14, 2008 and titled “Gesture input”; U.S. Patent Publication Number 20100306714 to Latta et al., published Dec. 2, 2010 and titled “Gesture shortcuts”; U.S. Patent Publication Number 2011/0209102 to Hinckley et al., published Aug. 25, 2011 and titled “Multi-screen dual tap gesture”; U.S. Pat. No. 8,902,181 to Hinckley Lord et al., issued Dec. 2, 2014 and titled “Multi-touch-movement gestures for tablet computing devices”; U.S. Pat. No. 8,988,398 to Cao et al., granted Mar. 24, 2015 and titled “Multi-touch input device with orientation sensing”; U.S. Patent Publication Number 20090100380 to Gardner et al., published Apr. 16, 2009 and titled “Navigating through content”; U.S. Pat. No. 7,627,834 to Rimas-Ribikauskas et al., granted Dec. 1, 2009 and titled “Method and system for training a user how to perform gestures”; U.S. Patent Publication Number 2011/0234504 to Barnett et al., published Sep. 29, 2011 and titled “Multi-axis navigation”; and U.S. patent application Ser. No. 16/193,082 to Kikin-Gil et al., filed on Nov. 16, 2018 and titled “System and Management of Semantic Indicators During Document Presentations”, the disclosures of each of which are herein incorporated by reference in their entirety.

The detailed examples of systems, devices, and techniques described in connection with FIGS. 1-14 are presented herein for illustration of the disclosure and its benefits. Such examples of use should not be construed to be limitations on the logical process implementations of the disclosure, nor should variations of user interface methods from those described herein be considered outside the scope of the present disclosure. In some implementations, various features described in FIGS. 1-14 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations, and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a particular processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In implementations in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across a number of machines. Processors or processor-implemented modules may be located in a single geographic location (for example, within a home or office environment, or a server farm), or may be distributed across multiple geographic locations.

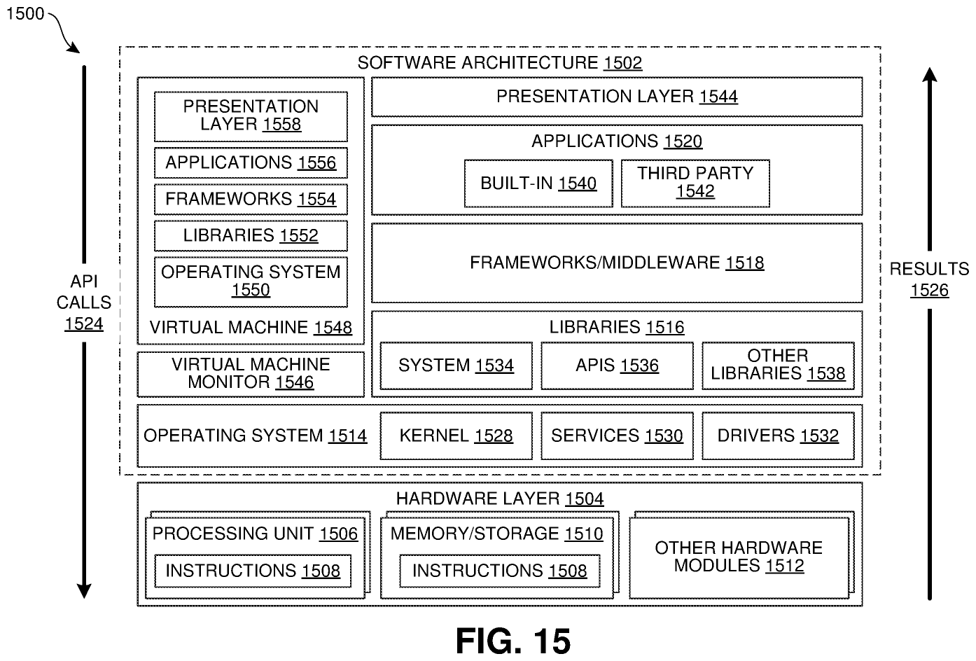

FIG. 15 is a block diagram 1500 illustrating an example software architecture 1502, various portions of which may be used in conjunction with various hardware architectures herein described, which may implement any of the above-described features. FIG. 15 is a non-limiting example of a software architecture and it will be appreciated that many other architectures may be implemented to facilitate the functionality described herein. The software architecture 1502 may execute on hardware that includes, among other things, document storage 1070, processors, memory, and input/output (I/O) components. A representative hardware layer 1504 is illustrated and can represent, for example, the device 150 of FIG. 1. The representative hardware layer 1504 includes a processing unit 1506 and associated executable instructions 1508. The executable instructions 1508 represent executable instructions of the software architecture 1502, including implementation of the methods, modules and so forth described herein. The hardware layer 1504 also includes a memory/storage 1510, which also includes the executable instructions 1508 and accompanying data. The hardware layer 1504 may also include other hardware modules 1512. Instructions 1508 held by processing unit 1508 may be portions of instructions 1508 held by the memory/storage 1510.

The example software architecture 1502 may be conceptualized as layers, each providing various functionality. For example, the software architecture 1502 may include layers and components such as an operating system (OS) 1514, libraries 1516, frameworks 1518, applications 1520, and a presentation layer 1544. Operationally, the applications 1520 and/or other components within the layers may invoke API calls 1524 to other layers and receive corresponding results 1526. The layers illustrated are representative in nature and other software architectures may include additional or different layers. For example, some mobile or special purpose operating systems may not provide the frameworks/middleware 1518.

The OS 1514 may manage hardware resources and provide common services. The OS 1514 may include, for example, a kernel 1528, services 1530, and drivers 1532. The kernel 1528 may act as an abstraction layer between the hardware layer 1504 and other software layers. For example, the kernel 1528 may be responsible for memory management, processor management (for example, scheduling), component management, networking, security settings, and so on. The services 1530 may provide other common services for the other software layers. The drivers 1532 may be responsible for controlling or interfacing with the underlying hardware layer 1504. For instance, the drivers 1532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1516 may provide a common infrastructure that may be used by the applications 1520 and/or other components and/or layers. The libraries 1516 typically provide functionality for use by other software modules to perform tasks, rather than rather than interacting directly with the OS 1514. The libraries 1516 may include system libraries 1534 (for example, C standard library) that may provide functions such as memory allocation, string manipulation, file operations. In addition, the libraries 1516 may include API libraries 1536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1516 may also include a wide variety of other libraries 1538 to provide many functions for applications 1520 and other software modules.

The frameworks 1518 (also sometimes referred to as middleware) provide a higher-level common infrastructure that may be used by the applications 1520 and/or other software modules. For example, the frameworks 1518 may provide various graphic user interface (GUI) functions, high-level resource management, or high-level location services. The frameworks 1518 may provide a broad spectrum of other APIs for applications 1520 and/or other software modules.

The applications 1520 include built-in applications 1540 and/or third-party applications 1542. Examples of built-in applications 1540 may include, but are not limited to, a contacts application, a browser application, a location application, a media application, a messaging application, and/or a game application. Third-party applications 1542 may include any applications developed by an entity other than the vendor of the particular platform. The applications 1520 may use functions available via OS 1514, libraries 1516, frameworks 1518, and presentation layer 1544 to create user interfaces to interact with users.

Some software architectures use virtual machines, as illustrated by a virtual machine 1548. The virtual machine 1548 provides an execution environment where applications/modules can execute as if they were executing on a hardware machine (such as the machine 1000 of FIG. 10, for example). The virtual machine 1548 may be hosted by a host OS (for example, OS 1514) or hypervisor, and may have a virtual machine monitor 1546 which manages operation of the virtual machine 1548 and interoperation with the host operating system. A software architecture, which may be different from software architecture 1502 outside of the virtual machine, executes within the virtual machine 1548 such as an OS 1550, libraries 1552, frameworks 1554, applications 1556, and/or a presentation layer 1558.

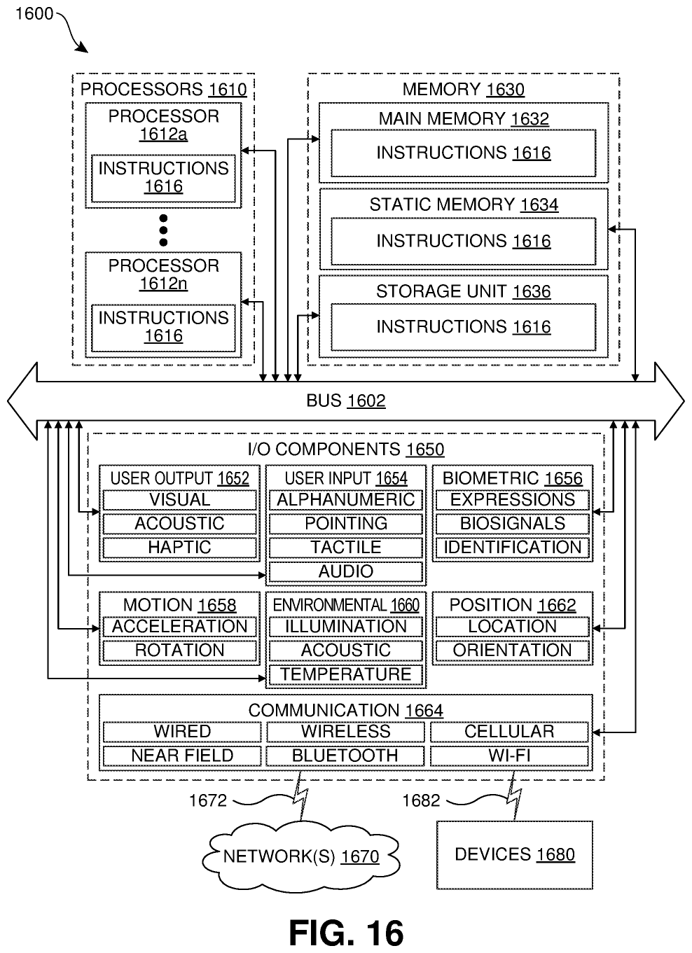

FIG. 16 is a block diagram illustrating components of an example machine 1600 configured to read instructions from a machine-readable medium (for example, a machine-readable storage medium) and perform any of the features described herein. The example machine 1600 is in a form of a computer system, within which instructions 1616 (for example, in the form of software components) for causing the machine 1600 to perform any of the features described herein may be executed. As such, the instructions 1616 may be used to implement modules or components described herein. The instructions 1616 cause unprogrammed and/or unconfigured machine 1600 to operate as a particular machine configured to carry out the described features. The machine 1600 may be configured to operate as a standalone device or may be coupled (for example, networked) to other machines. In a networked deployment, the machine 1600 may operate in the capacity of a server machine or a client machine in a server-client network environment, or as a node in a peer-to-peer or distributed network environment. Machine 1600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1600 is illustrated, the term “machine” includes a collection of machines that individually or jointly execute the instructions 1616.

The machine 1600 may include processors 1610, memory 1630, and I/O components 1650, which may be communicatively coupled via, for example, a bus 1602. The bus 1602 may include multiple buses coupling various elements of machine 1600 via various bus technologies and protocols. In an example, the processors 1610 (including, for example, a central processing unit (CPU), a graphics processing unit (GPU), a digital signal processor (DSP), an ASIC, or a suitable combination thereof) may include one or more processors 1612a to 1612n that may execute the instructions 1616 and process data. In some examples, one or more processors 1610 may execute instructions provided or identified by one or more other processors 1610. The term “processor” includes a multi-core processor including cores that may execute instructions contemporaneously. Although FIG. 16 shows multiple processors, the machine 1600 may include a single processor with a single core, a single processor with multiple cores (for example, a multi-core processor), multiple processors each with a single core, multiple processors each with multiple cores, or any combination thereof. In some examples, the machine 1600 may include multiple processors distributed among multiple machines.

The memory/storage 1630 may include a main memory 1632, a static memory 1634, or other memory, and a storage unit 1636, both accessible to the processors 1610 such as via the bus 1602. The storage unit 1636 and memory 1632, 1634 store instructions 1616 embodying any one or more of the functions described herein. The memory/storage 1630 may also store temporary, intermediate, and/or long-term data for processors 1610. The instructions 1616 may also reside, completely or partially, within the memory 1632, 1634, within the storage unit 1636, within at least one of the processors 1610 (for example, within a command buffer or cache memory), within memory at least one of I/O components 1650, or any suitable combination thereof, during execution thereof. Accordingly, the memory 1632, 1634, the storage unit 1636, memory in processors 1610, and memory in I/O components 1650 are examples of machine-readable media.

As used herein, “machine-readable medium” refers to a device able to temporarily or permanently store instructions and data that cause machine 1600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 1616) for execution by a machine 1600 such that the instructions, when executed by one or more processors 1610 of the machine 1600, cause the machine 1600 to perform and one or more of the features described herein. Accordingly, a “machine-readable medium” may refer to a single storage device, as well as “cloud-based” storage systems or storage networks that include multiple storage apparatus or devices.

The I/O components 1650 may include a wide variety of hardware components adapted to receive input, provide output, produce output, transmit information, exchange information, capture measurements, and so on. The specific I/O components 1650 included in a particular machine will depend on the type and/or function of the machine. For example, mobile devices such as mobile phones may include a touch input device, whereas a headless server or IoT device may not include such a touch input device. The particular examples of I/O components illustrated in FIG. 16 are in no way limiting, and other types of components may be included in machine 1600. The grouping of I/O components 1650 are merely for simplifying this discussion, and the grouping is in no way limiting. In various examples, the I/O components 1650 may include user output components 1652 and user input components 1654. User output components 1652 may include, for example, display components for displaying information (for example, a liquid crystal display (LCD) or a projector), acoustic components (for example, speakers), haptic components (for example, a vibratory motor or force-feedback device), and/or other signal generators. User input components 1654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1650 may include biometric components 1656 and/or position components 1662, among a wide array of other environmental sensor components. The biometric components 1656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 1662 may include, for example, location sensors (for example, a Global Position System (GPS) receiver), altitude sensors (for example, an air pressure sensor from which altitude may be derived), and/or orientation sensors (for example, magnetometers).

The I/O components 1650 may include communication components 1664, implementing a wide variety of technologies operable to couple the machine 1600 to network(s) 1670 and/or device(s) 1680 via respective communicative couplings 1672 and 1682. The communication components 1664 may include one or more network interface components or other suitable devices to interface with the network(s) 1670. The communication components 1664 may include, for example, components adapted to provide wired communication, wireless communication, cellular communication, Near Field Communication (NFC), Bluetooth communication, Wi-Fi, and/or communication via other modalities. The device(s) 1680 may include other machines or various peripheral devices (for example, coupled via USB).

In some examples, the communication components 1664 may detect identifiers or include components adapted to detect identifiers. For example, the communication components 1664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1662, such as, but not limited to, geo-location via Internet Protocol (IP) address, location via Wi-Fi, cellular, NFC, Bluetooth, or other wireless station identification and/or signal triangulation.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A system comprising:
a processor; and
computer readable media including instructions which, when executed by the processor, cause the processor to:
display, on a first device, a first user interface for interacting with a first application, the first user interface including a plurality of actuatable options for selecting content available via the first application, the plurality of actuatable options including a first option;
receive, via the touch-screen display, a first user input corresponding to a selection of the first option;
automatically display, in response to the first user selection, a first menu comprising a first set of sub-options that includes a first sub-option, a second sub-option, and a third sub-option, and wherein the first sub-option is associated with a visual indicator that denotes a currently targeted selection;
receive, via the touch-screen display, a second user input corresponding to a navigation between the first sub-option and the second sub-option, the second user input comprising a first swiping touch gesture in a first direction aligned with a first axis, wherein the visual indicator moves from the first sub-option to the second sub-option in response to the second user input;
receive, via the touch-screen display, a third user input corresponding to a selection of the second sub-option, the third user input comprising a second swiping touch gesture in a second direction aligned with a second axis that is substantially perpendicular relative to the first axis; and
automatically trigger execution of a task associated with the selection of the second sub-option.

2. The system of claim 1, wherein the first swiping touch gesture is applied from an upper-side of the touch-screen display to a lower-side of the touch-screen display, and the second swiping touch gesture is applied from a left side of the touch-screen display to a right-side of the touch-screen display.

3. The system of claim 1, wherein the first sub-option is directly adjacent to the second sub-option on the first menu.

4. The system of claim 1, wherein the first menu is positioned in a first portion of the touch-screen display and contact corresponding to the first swiping touch gesture occurs outside of the first portion.

5. The system of claim 1, wherein the first application comprises a text editor, and the first set of sub-options displays options for replacing portions of text also being displayed on the touch-screen display.

6. The system of claim 1, wherein the first user input comprises a tap on the touch-screen display.

7. The system of claim 1, wherein the first set of sub-options are displayed as a cascading menu extending in a direction substantially parallel to the first axis.

8. The system of claim 1, wherein the instructions further cause the processor to:
receive, via the touch-screen display, a fourth user input corresponding to a navigation from the second sub-option to the third sub-option, the fourth user input comprising a third swiping touch gesture in the first direction, wherein the visual indicator moves from the second sub-option to the third sub-option in response to the fourth user input; and
receive, via the touch-screen display, a fifth user input corresponding to a navigation from the third sub-option to the second sub-option, the fifth user input comprising a fourth swiping touch gesture in a third direction substantially opposite to the first direction, wherein the visual indicator moves from the third sub-option to the second sub-option in response to the fifth user input.

9. The system of claim 4, wherein the instructions further cause the processor to:
receive, via the touch-screen display, a fourth user input corresponding to a dismissal of the first menu, the fourth user input comprising a tap on the touch-screen display that is outside of the first portion; and
remove, in response to the fourth user input, the display of the first menu.

10. The system of claim 1, wherein the instructions further cause the processor to:
receive, via the touch-screen display, a fourth user input corresponding to an undo command, the fourth user input comprising a third swiping touch gesture in a third direction aligned with a second axis that is substantially perpendicular relative to the first axis that is opposite to the first direction; and
undo, in response to the fourth user input, the execution of the task

11. A method for navigating user interface options via a touch-screen display of a computing device, the method comprising:
displaying, on a first device, a first user interface for interacting with a first application, the first user interface including a plurality of actuatable options for selecting content available via the first application, the plurality of actuatable options including a first option;
receiving, via the touch-screen display, a first user input corresponding to a selection of the first option;
automatically displaying, in response to the first user selection, a first menu comprising a first set of sub-options that includes a first sub-option, a second sub-option, and a third sub-option, and wherein the first sub-option is associated with a visual indicator that denotes a currently targeted selection;
receiving, via the touch-screen display, a second user input corresponding to a navigation between the first sub-option and the second sub-option, the second user input comprising a first swiping touch gesture in a first direction aligned with a first axis, wherein the visual indicator moves from the first sub-option to the second sub-option in response to the second user input;
receiving, via the touch-screen display, a third user input corresponding to a selection of the second sub-option, the third user input comprising a second swiping touch gesture in a second direction aligned with a second axis that is substantially perpendicular relative to the first axis; and
automatically triggering execution of a task associated with the selection of the second sub-option.

12. The method of claim 11, wherein the first swiping touch gesture is applied from an upper-side of the touch-screen display to a lower-side of the touch-screen display, and the second swiping touch gesture is applied from a left side of the touch-screen display to a right-side of the touch-screen display.

13. The method of claim 11, wherein the first sub-option is directly adjacent to the second sub-option on the first menu.

14. The method of claim 11, wherein the first menu is positioned in a first portion of the touch-screen display and contact corresponding to the first swiping touch gesture occurs outside of the first portion.

15. The method of claim 11, wherein the first application comprises a text editor, and the first set of sub-options displays options for replacing portions of text also being displayed on the touch-screen display.

16. The method of claim 11, wherein the first user input comprises a tap on the touch-screen display.

17. The method of claim 11, wherein the first set of sub-options are displayed as a cascading menu extending in a direction substantially parallel to the first axis.

18. The method of claim 11, further comprising:
receiving, via the touch-screen display, a fourth user input corresponding to a navigation from the second sub-option to the third sub-option, the fourth user input comprising a third swiping touch gesture in the first direction, wherein the visual indicator moves from the second sub-option to the third sub-option in response to the fourth user input; and
receiving, via the touch-screen display, a fifth user input corresponding to a navigation from the third sub-option to the second sub-option, the fifth user input comprising a fourth swiping touch gesture in a third direction substantially opposite to the first direction, wherein the visual indicator moves from the third sub-option to the second sub-option in response to the fifth user input.

19. The method of claim 14, further comprising:
receiving, via the touch-screen display, a fourth user input corresponding to a dismissal of the first menu, the fourth user input comprising a tap on the touch-screen display that is outside of the first portion; and
removing, in response to the fourth user input, the display of the first menu.

20. A computer readable medium including instructions stored therein which, when executed by a processor, cause the processor to perform operations comprising:
display, on a first device, a first user interface for interacting with a first application, the first user interface including a plurality of actuatable options for selecting content available via the first application, the plurality of actuatable options including a first option;
receive, via the touch-screen display, a first user input corresponding to a selection of the first option;
automatically display, in response to the first user selection, a first menu comprising a first set of sub-options that includes a first sub-option, a second sub-option, and a third sub-option, and wherein the first sub-option is associated with a visual indicator that denotes a currently targeted selection;
receive, via the touch-screen display, a second user input corresponding to a navigation between the first sub-option and the second sub-option, the second user input comprising a first swiping touch gesture in a first direction aligned with a first axis, wherein the visual indicator moves from the first sub-option to the second sub-option in response to the second user input;
receive, via the touch-screen display, a third user input corresponding to a selection of the second sub-option, the third user input comprising a second swiping touch gesture in a second direction aligned with a second axis that is substantially perpendicular relative to the first axis; and
automatically trigger execution of a task associated with the selection of the second sub-option.
